(19) United States
(12) Patent Application Publication
(10) Pub. No.: US 2024/0408715 A1
(43) Pub. Date: Dec. 12, 2024

(54) Handheld power tool, in particular a sander, handheld power tool device, protective device, handheld power tool system, and method for manufacturing a handheld power tool device

(71) Applicant: Robert Bosch GmbH, Stuttgart (DE)

(72) Inventors: Daniel Barth, Leinfelden-Echterdingen (DE); Florian Esenwein, Leinfelden-Echterdingen (DE)

(21) Appl. No.: 18/732,951

(22) Filed: Jun. 4, 2024

(30) Foreign Application Priority Data
Jun. 9, 2023 (DE) 10 2023 205 364.0

(51) Int. Cl. B24B 23/02; B24B 47/12; B24B 47/26

(52) U.S. Cl. CPC B24B 23/02; B24B 47/12; B24B 47/26

(57) ABSTRACT

A sander, in particular a battery-operated sander, preferably an orbital sander or random orbital sander having a tool holder, in particular a sanding pad, includes a drive unit for driving the tool holder and a housing unit having a bow-shaped handle. A ratio between a maximum longitudinal extent of a handle recess of the bow-shaped handle and a maximum longitudinal extent of the tool holder is at least 0.35 and at most 0.5.

### PRIOR ART

A sander comprising a tool holder, which comprises a drive unit for driving the tool holder and comprises a housing unit having a bow-shaped handle, has previously been proposed.

### DISCLOSURE OF THE INVENTION

The invention is based on a sander, in particular a battery-operated sander, preferably an orbital sander or random orbital sander comprising a tool holder, in particular a sanding pad, said sander comprising a drive unit for driving the tool holder and comprising a housing unit which has a bow-shaped handle.

It is proposed that a ratio between a maximum longitudinal extent of a handle recess of the bow-shaped handle and a maximum longitudinal extent of the tool holder is at least 0.35 and at most 0.5. A sander with particularly favorable ergonomic properties can be provided in an advantageous manner. Advantageously, particularly depending on the size of the tool holder, a particularly large amount of space can be provided for an operator's fingers in the handle recess for guiding the sander. Particularly precise and/or safe handling of the sander can be achieved. A particularly high level of operating convenience can be achieved in an advantageous manner.

The sander is preferably designed as a battery-operated sander. Alternatively, however, it is also conceivable that the sander is designed as a grid-powered sander. The sander is preferably designed as a random orbital sander. Alternatively, however, it is also conceivable that the sander is designed as an orbital sander, a delta sander, a flower sander, or the like.

The tool holder is preferably designed as a sanding pad. The tool holder is preferably designed as a round sanding pad. Alternatively, however, it is also conceivable that the tool holder is designed as a delta pad, as a square, preferably rectangular, sanding pad or as another sanding pad that a skilled person considers useful. In particular, the tool holder comprises fastening means for fastening a tool, preferably a sanding means. The fastening means comprise, e.g., one or multiple Velcro surfaces, one or multiple clips, a combination of these, or other fastening means that a skilled person considers useful. The sanding means is preferably designed as an abrasive paper, an abrasive fleece, an abrasive grid, or the like.

In particular, the drive unit comprises a drive element, preferably an eccentric. The drive element is preferably intended to be driven around a drive axis of the drive unit. The sander preferably comprises an output unit. In particular, the tool holder is a portion of the output unit. The output unit preferably comprises a connecting piece. The connecting piece is arranged on the drive element, preferably attached. The tool holder is preferably attached to the connecting piece, in particular non-rotatably, e.g. by means of a screw or the like. In particular, the output element has an output axis. The output axis preferably extends at least substantially parallel to the drive axis. In particular, the drive axis is at a distance from the output axis. The term “substantially parallel” can in this context be understood to mean an orientation of a direction relative to a reference direction, in particular in a plane, whereby the direction has a deviation relative to the reference direction that is in particular less than 8°, advantageously less than 5°, and particularly advantageously less than 2°. In particular, the connecting piece and/or the tool holder, preferably the output axis, moves in at least one operating state around the drive axis, preferably in a circular motion. In particular, the drive element is intended to move the connecting piece and/or the tool holder, preferably the output axis, in a preferably circular motion about the drive axis of the tool holder.

The term “intended” should be understood to mean specially furnished, specially designed, and/or specially equipped. An object being “intended” for a specific function is understood to mean that the object fulfills and/or performs this specific function in at least one application and/or operating state.

The connecting piece is preferably rotatably attached to the drive element, in particular rotatable about the output axis. The sander preferably comprises at least one bearing element. In particular, the connecting piece is mounted on the drive element so that it can rotate via the bearing element, preferably about the output axis. The bearing element is preferably arranged between the drive element and the connecting piece. The bearing element is preferably designed as a radial bearing, in particular as a rolling bearing, e.g. a ball bearing, or as a plain bearing.

The drive unit is preferably intended to drive the output unit, in particular the tool holder. The drive unit preferably comprises an electric motor of the like, in particular for driving the drive element.

The sander preferably comprises a housing unit. The housing unit preferably comprises a drive housing to hold the drive unit. The drive housing preferably comprises a fan housing to hold an extraction fan. Preferably, the extraction fan is intended to extract the material removed from the workpiece during machining and, in particular, to blow it out of a dust outlet of the sander. The drive housing preferably comprises a motor housing to hold the drive unit. The fan housing is preferably arranged between the motor housing and the tool holder. The extraction fan is preferably made of metal, in particular cast. Alternatively, however, it is also conceivable that the extraction fan is made of plastic or a combination of plastic and metal.

In particular, the housing unit comprises a handle housing. The bow-shaped handle is preferably a portion of the handle housing. The handle housing preferably has two handle housing shells, which are connected to each other in particular in a separation plane of the handle housing. The handle housing is preferably arranged separately from the drive housing, in particular at a distance from the drive housing. In particular, the handle housing comprises a shell structure, with the two handle housing shells acting as half shells.

The bow-shaped handle preferably comprises a finger grip surface. The bow-shaped handle preferably comprises two walls, in particular lateral walls, which delimit the finger grip surface, in particular in a main extension plane of the bow-shaped handle and viewed in a direction perpendicular to the drive axis. The “main extension plane” of a structural unit or an element can be understood to mean a plane which is parallel to a largest side surface of a smallest possible imaginary cuboid, which just completely encloses the structural unit, and in particular extends through the center of the cuboid. The bow-shaped handle is preferably designed as a closed bow-shaped handle. Alternatively, however, it is also conceivable that the bow-shaped handle is designed as an open bow-shaped handle. Preferably, the walls at least partially define, in particular delimit, the handle recess.

The maximum longitudinal extent of the handle recess preferably extends at least substantially parallel to a tool holder surface of the tool holder. The maximum longitudinal extent of the handle recess preferably extends in the main extension plane of the bow-shaped handle, preferably in a main extension plane of the handle housing, in particular in the separating plane of the handle housing. Preferably, the main extension plane of the bow-shaped handle corresponds to the main extension plane of the handle housing. Alternatively, it is conceivable that the main extension plane of the bow-shaped handle is different from the main extension plane of the handle housing. The separating plane is preferably congruent with the main extension plane of the handle housing and/or the main extension plane of the bow-shaped handle. Alternatively, however, it is also conceivable that the main extension plane of the bow-shaped handle and/or the main extension plane of the handle housing are/is different from the separating plane.

The tool holder surface preferably extends at least substantially perpendicular to the separating plane, the main extension plane of the handle housing, and/or the main extension plane of the bow-shaped handle. The term “substantially perpendicular” can be understood to mean an orientation of a direction relative to a reference direction, whereby, in particular viewed in a projection plane, the direction and the reference direction enclose an angle of 90° and the angle has a maximum deviation of in particular less than 8°, advantageously less than 5°, and particularly advantageously less than 2°.

In particular, the maximum longitudinal extent of the tool holder extends at least substantially parallel to the maximum longitudinal extent of the handle recess and/or the tool holder surface. The maximum longitudinal extent of the tool holder preferably extends along the separating plane of the handle housing, the main extension plane of the handle housing, and/or along the main extension plane of the bow-shaped handle. The maximum longitudinal extent of the tool holder is defined in particular by a maximum longitudinal extent of the tool holder surface. In particular, the tool is intended to be arranged on the tool holder surface.

Preferably, the ratio between the maximum longitudinal extent of the handle recess of the bow-shaped handle and the maximum longitudinal extent of the tool holder is at least 0.38. Preferably, the ratio between the maximum longitudinal extent of the handle recess of the bow-shaped handle and the maximum longitudinal extent of the tool holder is at most 0.42. The ratio between the maximum longitudinal extent of the handle recess of the bow-shaped handle and the maximum longitudinal extent of the tool holder is at least substantially 0.4. The maximum longitudinal extent of the handle recess is preferably at least 50 mm, preferably at least 55 mm, and particularly preferably at least 60 mm. The maximum longitudinal extent of the handle recess is preferably at most 80 mm, preferably at most 70 mm, and particularly preferably at most 75 mm. Particularly preferably, the maximum longitudinal extent of the handle is at least substantially 61 mm. Alternatively, however, it is also conceivable that the maximum longitudinal extent of the handle recess is greater than 80 mm or less than 50 mm.

In particular, the handle housing comprises a palm grip, in particular a grip knob. The palm grip is preferably arranged such that the drive axis intersects the palm grip. The bow-shaped handle merges into the palm grip in particular. In particular, the fan housing is located between the tool holder and the palm grip. The handle housing, in particular the palm grip, surrounds the motor housing, preferably at least in a plane perpendicular to the drive axis.

The sander preferably comprises a battery pack interface for electrical and/or mechanical connection to a battery pack. In particular, the battery pack interface comprises guidance means, e.g. one or multiple guide rails or the like, for guiding the battery pack during assembly and/or disassembly at the battery pack interface. The battery pack interface, in particular the guidance means, preferably specifies an insertion direction for the battery pack when the battery pack is mounted on the battery pack interface. The insertion direction preferably extends at least substantially perpendicular to the drive axis, to the separating plane, to the main extension plane of the bow-shaped handle, and/or to the main extension plane of the handle housing. In particular, the insertion direction extends at least substantially parallel to the tool holder surface. Preferably, the battery pack interface is arranged on the handle housing, in particular on a side of the bow-shaped handle facing away from the palm grip. In particular, the battery pack interface has no interface with the drive axis and/or a main extension plane of the tool holder surface.

Preferably, the handheld power tool, in particular the sander, comprises at least one input element. Preferably, the handheld power tool can be switched on and/or off by the operator actuating the input element. Alternatively or additionally, it is conceivable that the input element can be used to adjust the rotational speed of the handheld power tool or the like. The input element can, e.g., be designed as a button, a rotary wheel, a switch, or the like. The input element is, e.g., arranged on the palm grip, preferably on a side of the palm grip facing away from the battery pack interface, the tool holder, and/or the bow-shaped handle.

The sander is preferably intended for one-handed operation, in particular by means of the bow-shaped handle and the palm grip. Alternatively, however, it is also conceivable that the sander is designed as a two-handed guide, in which case one hand of the operator is arranged on the palm grip and one on the bow-shaped handle.

In one aspect of the invention, which can be considered in particular on its own as well as in conjunction with other aspects of the invention, the invention is based on a handheld power tool device, in particular a handheld sander device, for a handheld power tool, in particular a sander, preferably the sander specified hereinabove, comprising a housing unit, in particular the housing unit specified hereinabove, which comprises at least one handle housing, in particular the handle housing specified hereinabove, and a drive housing, in particular the drive housing specified hereinabove, which is coupled to the handle housing. It is proposed that the drive housing comprises, on a surface of an upper side of the drive housing, a center bar which is raised relative to the surface and above which, in particular, one end of the handle housing is arranged, whereby the center bar slopes down onto the surface in both directions, starting from a main extension plane of the handle housing, in particular the main extension plane of the handle housing specified hereinabove, and perpendicular to the main extension plane of the handle housing.

Advantageously, a design of the drive housing with such a center bar enables a particularly space-saving design of the handheld power tool device, in particular with regard to the overall height of the handheld power tool. A particularly large gripping surface can be achieved on the handle housing. Contact between an operator's fingers and the drive housing can be efficiently counteracted in an advantageous manner. The operator can be protected particularly efficiently against vibrations. A particularly high level of operating convenience can be achieved in an advantageous manner. Particularly precise and/or safe guidance of the handheld power tool can be achieved.

The center bar in particular projects from the adjoining surface. A maximum transverse extent of the center bar is preferably smaller than a maximum overall transverse extent of the handle housing. The maximum transverse extent of the center bar preferably extends at least substantially perpendicular to the main extension plane of the bow-shaped handle, the main extension plane of the handle housing, the separating plane, and/or the drive axis. In particular, the maximum transverse extent of the center bar extends at least substantially parallel to the tool holder surface of the tool holder. The maximum transverse extent of the center bar is preferably smaller than a maximum transverse extent of the handle housing at the end of the center bar arranged above the center bar. The end of the handle housing is arranged above the center bar, particularly in relation to the tool holder and/or the surface.

The center bar preferably comprises a main extension axis. A “main extension axis” of an object can be understood in particular as an axis that extends parallel to a longest edge of a smallest geometric cuboid that just completely encloses the object, and in particular extends through the center of the cuboid. In particular, the main extension axis of the center bar extends at least substantially perpendicular to the drive axis and/or to the maximum transverse extent of the center bar. In particular, the main extension axis of the center bar extends at least substantially parallel to the main extension plane of the bow-shaped handle, to the main extension plane of the handle housing, to the separating plane, and/or to the tool holder surface. Preferably, the main extension axis of the center bar extends along the main extension plane of the bow-shaped handle, along the main extension plane of the handle housing, and/or along the separating plane.

The center bar extends, preferably at least in the direction of the main extension axis of the center bar, in particular over a large portion of the surface, preferably over at least 50%, preferably over at least 75% and particularly preferably over 90% of the surface. The upper side, preferably the surface, is arranged facing away from the tool holder. The center bar has a curvature, preferably a curvature adapted to the surface, particularly in the longitudinal direction, preferably in the direction of the main extension axis of the center bar. Alternatively, however, it is also conceivable that the center bar is designed without a curvature in the longitudinal direction.

In one aspect of the invention, which can be considered in particular on its own as well as in conjunction with other aspects of the invention, the invention is based on a handheld power tool system with a sander, in particular the sander specified hereinabove, preferably an orbital sander or a random orbital sander, and with a battery pack for supplying power to the sander. It is proposed that the handheld power tool system comprises a support unit which is designed for placing and/or storing the sander on a base in at least one placement and/or storage position, whereby the battery pack comprises a support surface of the support unit for the at least one placement and/or storage position.

The battery pack can be used to ensure that the sander stands securely. An operator can conveniently place the sander in an advantageous manner. An operator can place or store the sander via the battery pack for cleaning, maintenance, or the like of the handheld power tool and/or a tool arranged on the sander. A particularly high level of operating convenience can be achieved.

It is conceivable that a support point or a support line forms the support surface. It is also conceivable that the support surface comprises multiple support points, in particular at a distance from one another. Preferably, the support surface is a continuous surface that rests on the base, particularly in the at least one placement and/or storage position. The work surface can be a floor, a table, or the like. In particular, the battery pack comprises a battery pack housing. The battery pack housing comprises the support surface.

It is conceivable that the support unit is designed for placing and/or storing the sander on the work surface in at least one further placement and/or storage position. For example, the battery pack comprises a further support surface of the support unit for the at least one further placement and/or storage position. It is also conceivable that the housing unit, in particular the handle housing and/or the drive housing, comprises at least one additional support surface for the placement and/or storage position and/or for the at least one further placement and/or storage position.

In one aspect of the invention, which can be considered in particular on its own as well as in conjunction with other aspects of the invention, the invention is based on a protective device, in particular a wall protection ring, for collision protection of a tool, in particular the tool(s) specified hereinabove, which can be arranged on the handheld power tool and/or a tool holder, in particular a sanding pad, of the handheld power tool with objects in a working environment of the handheld power tool. It is proposed that the protective device comprises a shutter unit and/or a light guide unit for at least one light source.

Particularly efficient and/or precise illumination of a workpiece to be processed by the handheld power tool can be achieved. Such a design of the handheld power tool device can counteract blinding of the operator. Advantageously, a particularly high level of operating comfort and/or safety can be achieved.

The protective device is designed in particular as a protective ring. The protective device is preferably intended as a bumper for the handheld power tool. In particular, the protective device is intended to counteract an impact of the tool holder and/or the tool arranged on the tool holder against walls or the like in the working environment. The protective device is preferably arranged on the drive housing in at least one operating state. Preferably, the protective device is intended for arrangement on the fan housing.

The shutter unit is in particular intended to shield an region from the incidence of light from the at least one light source. The shutter unit comprises, e.g., at least one shutter element. Alternatively, however, it is also conceivable that the shutter unit comprises multiple shutter elements. The shutter element is preferably an opaque component. It is conceivable that the shutter element is designed as a reflector, e.g. as a mirror or the like.

The protective device preferably comprises a base body. It is conceivable that the shutter unit, in particular the at least one shutter element, is designed to be integral with the base body. It is conceivable that the shutter unit, in particular the at least one shutter element, is formed by the base body of the protective device. Alternatively, it is also conceivable that the shutter unit, in particular the at least one shutter element, is designed to be separate from the base body. In particular, it is conceivable that the shutter unit, preferably the at least one shutter element, can be attached to the base body, preferably detachably. In this context, the term “detachable” is in particular understood to mean “non-destructively separable”. It is also conceivable that the shutter unit, in particular the at least one shutter element, can be arranged adjustably on the base body, preferably in order to adapt a shielding region by the shutter unit.

The light guide unit is preferably arranged on the base body and/or the shutter unit. For example, the light guide unit comprises at least one light guide element and preferably multiple light guide elements. In particular, the light guide unit is intended to guide and/or emit light from the at least one light source. The at least one light guide element is, e.g., designed as a transparent fiber, tube, or rod. It is also conceivable that the light guide unit comprises at least one emitting element, in particular a light-scattering element, e.g. in the form of a roughening, a scattering glass, plastic or ceramic plate, a scattering plastic film, or the like. The radiating element is preferably arranged on the base body and/or the shutter unit. It is also conceivable that the radiating element is a portion of the light guide element or forms the light guide element.

The at least one light source is, e.g., a portion of the handheld power tool, in particular the sander. Alternatively or additionally, however, it is also conceivable that the light source is a portion of the protective device. The light source is, e.g., designed as an LED, an incandescent lamp, or another light source that a skilled person considers useful.

In one aspect of the invention, which can be considered in particular on its own as well as in conjunction with other aspects of the invention, the invention is based on a handheld power tool device, in particular the one specified hereinabove comprising a housing unit, in particular the one specified hereinabove, which comprises a handle housing, in particular the one specified hereinabove, and a handle housing, in particular the one specified hereinabove for accommodating a drive unit, preferably the one specified hereinabove, whereby the drive housing defines a drive axis, in particular the one specified hereinabove, of the drive unit, and comprising a damping unit which couples the drive housing to the handle housing. It is proposed that the drive housing comprises an extension arm, which extends at least radially with respect to the drive axis and on which at least a portion of the damping unit is arranged.

Advantageously, a particularly efficient decoupling of the handle housing from vibrations on the drive housing can be achieved using simultaneously particularly precise and/or comfortable handheld power tool guidance. A particularly high level of operating convenience can be achieved. A particularly wide support of the drive housing on the handle housing can be advantageously achieved. A particularly stable guidance for the handheld power tool can be achieved in an advantageous manner. A particularly high level of operating safety can be achieved.

In particular, the motor housing provides the drive axis. Preferably, the motor housing comprises a motor holder, in the central longitudinal axis of which a motor axis comes to rest. The drive axis is defined in particular by the motor axis. In particular, the central longitudinal axis is congruent with the drive axis.

The damping unit preferably comprises multiple damping elements. The damping elements are preferably made of at least one elastic material, in particular an elastic plastic. The damping elements can be designed as blocks, rings, ring segments, plates, or the like. The drive housing is preferably connected to the handle housing via the damping elements. The damping unit is in particular intended to decouple the handle housing from the drive housing from vibrations. The handle housing is preferably only connected to the drive housing via the damping unit, in particular the damping elements of the damping unit.

At least a portion of the damping elements can preferably be fixed between the drive housing and the handle housing by means of a clamp. It is also conceivable that the damping elements comprise an adhesive layer for attachment to the drive housing and/or the handle housing. Additionally or alternatively, it is conceivable that at least a portion of the damping elements can be attached to the handle housing and/or the drive housing by means of damping element holders, e.g. recesses, holding bolts, or the like, and/or by means of a screw connection or the like.

In particular, the handle housing is coupled to the drive housing via two different coupling regions of the damping unit. Preferably, the handle housing comprises two inner regions, in particular at a distance from each other, within each of which a portion of the drive housing is arranged. In particular, the two coupling regions are arranged in the two inner regions.

The extension arm is preferably arranged on a side of the drive housing facing the battery pack interface. The extension arm is preferably arranged inside the handle housing, in particular in an inner region of the two inner regions of the handle housing. The extension arm forms an outermost point of the drive housing, in particular when viewed in a direction perpendicular to the drive axis and extending in the separation plane. The extension arm is preferably at least partially enclosed by the handle housing.

The portion of the damping unit arranged on the extension arm in particular comprises at least one damping element of the damping elements. The extension arm preferably comprises at least one damping element holder for the at least one damping element. The shape of the damping element is preferably adapted to the damping element holder. The damping element holder is, e.g., designed as a holding bolt, in particular for holding a ring-shaped damping element. The damping element holder is, e.g., intended to hold the at least one damping element perpendicular to the main extension plane of the handle housing, in particular to the main extension plane of the bow-shaped handle, and/or to the separation plane. The extension arm is, e.g., designed to be T-shaped, in particular to hold at least two damping elements. Alternatively, however, it is also conceivable that the damping element holder is, e.g., designed as a recess, in particular for holding a damping element designed as a block, plate, or the like. It is conceivable that the at least one damping element is fixed to the damping element holder by the handle housing, in particular the handle housing shells. Alternatively or additionally, however, it is also conceivable that the damping element is glued, screwed, or the like to the damping element holder.

In one aspect of the invention, which can in particular be considered independently of further aspects of the invention, it is proposed that a sander center of gravity is arranged in the handle recess of the bow-shaped handle. A particularly high level of comfort can be achieved when handling handheld power tools. A particularly favorable weight distribution can be achieved in an advantageous manner. Particularly favorable ergonomic properties can be achieved. Preferably, the center of gravity is arranged within the handle recess at least in a direction perpendicular to the main extension plane of the handle housing, in particular to the main extension plane of the handle housing, when viewed from within the handle recess. A minimum distance of the center of gravity from the separating plane of the handle housing, from the main extension plane of the handle housing and/or from the main extension plane of the bow-shaped handle is preferably smaller than a maximum transverse extent of the handle housing, in particular of the bow-shaped handle, starting from the separating plane of the handle housing, the main extension plane of the handle housing, or the main extension plane of the bow-shaped handle. It is also conceivable that the center of gravity is arranged in the separating plane of the handle housing, in the main extension plane of the handle housing, and/or in the main extension plane of the bow-shaped handle. The maximum transverse extent of the handle housing, in particular of the bow-shaped handle, preferably starting from the separating plane of the handle housing, the main extension plane of the handle housing, and/or the main extension plane of the bow-shaped handle, preferably extends at least substantially perpendicular to the main extension plane of the bow-shaped handle, in particular to the main extension plane of the handle housing, the separating plane, and/or to the drive axis. The maximum transverse extent of the handle housing, in particular of the bow-shaped handle, preferably starting from the separating plane of the handle housing, the main extension plane of the handle housing, and/or the main extension plane of the bow-shaped handle, preferably extends at least substantially parallel to the tool holder surface.

It is further proposed that a ratio of a maximum distance of the tool holder from the center of gravity in the direction of the drive axis to a minimum distance between the drive axis and the center of gravity is at least 2.8 and at most 3.5. Advantageously, a particularly favorable weight distribution can be achieved with regard to handling and/or guiding the handheld power tool. A particularly high level of operating comfort and/or particularly favorable ergonomic properties of the sander can be achieved in an advantageous manner. Preferably, the ratio of the maximum distance of the tool holder from the center of gravity in the direction of the drive axis to the minimum distance between the drive axis and the center of gravity is at least 3.0, particularly preferably at least 3.1. Preferably, the ratio of the maximum distance of the tool holder from the center of gravity in the direction of the drive axis to the minimum distance between the drive axis and the center of gravity at most 3.2. The maximum distance between the tool holder and the center of gravity in the direction of the drive axis is defined in particular by a maximum distance between the tool holder surface and the center of gravity in the direction of the drive axis. The maximum distance between the tool holder and the center of gravity in the direction of the drive axis is in particular at least 30 mm, preferably at least 33 mm, preferably at least 35 mm. The maximum distance between the tool holder and the center of gravity in the direction of the drive axis is in particular at most 50 mm, preferably at most 45 mm, and particularly preferably at most 40 mm. For example, the maximum distance between the tool holder and the center of gravity in the direction of the drive axis is at least substantially 38 mm. Alternatively, however, it is also conceivable that the maximum distance between the tool holder and the center of gravity in the direction of the drive axis is less than 30 mm or greater than 50 mm. The minimum distance between the drive axis and the center of gravity is at least 8 mm, preferably at least 10 mm. The minimum distance between the drive axis and the center of gravity is at most 20 mm, preferably at most 15 mm. For example, the minimum distance of the drive axis to the center of gravity is at least substantially 12 mm. Alternatively, however, it is also contemplated that the minimum distance of the drive axis to the center of gravity is less than 8 mm or greater than 20 mm. In particular, the drive axis extends at least substantially perpendicular to the tool holder surface. The drive axis extends in particular at least substantially parallel to the main extension plane of the handle housing, in particular to the main extension plane of the bow-shaped handle, and/or to the separation plane. It is conceivable that the drive axis extends in the main extension plane of the handle housing, in the main extension plane of the bow-shaped handle, and/or in the separating plane. The minimum distance between the drive axis and the center of gravity is at least substantially perpendicular to the drive axis. The minimum distance between the drive axis and the center of gravity extends in particular at least substantially parallel to the tool holder surface, to the main extension plane of the handle housing, to the main extension plane of the bow-shaped handle, and/or to the separating plane.

It is also proposed that a maximum height of the sander in the direction of the drive axis has a ratio of at least 2.8 and at most 3.2 to a maximum distance between the tool holder and the center of gravity in the direction of the drive axis, in particular the maximum distance specified hereinabove. The center of gravity of the handheld power tool is particularly low in relation to the maximum height of the sander. Advantageously, a particularly favorable weight distribution and/or particularly favorable ergonomic properties can be achieved with regard to handling and/or guiding the handheld power tool. A particularly high level of operating convenience can be achieved. A particularly high stability of the sander can be achieved in an advantageous manner. The ratio of the maximum height of the sander in the direction of the drive axis to the maximum distance between the tool holder and the center of gravity in the direction of the drive axis is preferably at least 3.0. The ratio of the maximum height of the sander in the direction of the drive axis to the maximum distance between the tool holder and the center of gravity in the direction of the drive axis is preferably 3.1 or less. The maximum height of the sander in the direction of the drive axis preferably extends from the tool holder surface parallel to the drive axis to an outermost point of the handle housing. The maximum height of the sander is preferably at least 100 mm, preferably at least 110 mm. The maximum height of the sander is preferably at most 130 mm, preferably at most 120 mm. Alternatively, however, it is also conceivable that the maximum height of the sander towards the drive axis is less than 110 mm or greater than 130 mm. A ratio of the maximum height of the sander to a maximum height of the handle recess in a direction parallel to the drive axis is preferably at least 4.0, preferably at least 4.3, particularly preferably at least 4.4, and at most 5.0, preferably at most 4.7, particularly preferably at most 4.6. The maximum height of the handle recess is preferably between 20 mm and 30 mm, preferably between 24 mm and 28 mm and particularly preferably at least substantially 26 mm.

It is further proposed that the handle recess of the bow-shaped handle is closed, preferably substantially oval closed. The fingers of the operator can be protected particularly efficiently in an advantageous manner. Advantageously, the handle housing can be additionally supported by the closed bow-shaped handle. A particularly high stability of the handheld power tool can be achieved in an advantageous manner. In particular, the handle recess is closed when viewed in the main extension plane of the bow-shaped handle, in the main extension plane of the handle housing, and/or in the separating plane. The handle recess is closed in particular by walls of the drive housing, in particular the fan housing of the drive housing, and the handle housing. Alternatively, it is conceivable that the handle recess is completely closed by the walls of the handle housing. The handle recess preferably has an oval shape, in particular when viewed in a direction perpendicular to the main extension plane of the bow-shaped handle, preferably to the main extension plane of the handle housing. Alternatively, however, it is also conceivable that the handle recess has a rectangular shape, a square shape, a circular shape, or any other shape that a skilled person considers useful, in particular when viewed in the direction perpendicular to the main extension plane of the bow-shaped handle, preferably to the main extension plane of the handle housing.

It is further proposed that the battery pack has a battery pack center of gravity which, in a state arranged on the sander, is offset from the main extension plane of the bow-shaped handle. Design-related shifts in the sander center of gravity in relation to the main extension plane of the bow-shaped handle can be compensated for in an advantageous manner. A handheld power tool system with a particularly favorable weight distribution can be provided. A particularly ergonomic handheld power tool system can be provided in an advantageous manner. A particularly high level of operating convenience can be achieved. A minimum distance of the battery pack center of gravity from the separating plane of the handle housing, from the main extension plane of the handle housing, and/or from the main extension plane of the bow-shaped handle is preferably smaller than the maximum transverse extent of the handle housing, in particular of the bow-shaped handle, starting from the separating plane of the handle housing, the main extension plane of the handle housing, or the main extension plane of the bow-shaped handle. In particular, the minimum distance of the battery pack center of gravity from the separation plane of the handle housing, from the main extension plane of the handle housing and/or from the main extension plane of the bow-shaped handle is less than 20 mm, preferably less than 15 mm, and preferably less than 10 mm.

It is also proposed that the sander comprises a dust outlet, in particular the dust outlet specified hereinabove, whereby the battery pack center of gravity and the dust outlet are arranged on different sides of the main extension plane of the bow-shaped handle. Advantageously, an eccentric displacement of the center of gravity with respect to the main extension plane of the bow-shaped handle can be minimized by the battery pack or the dust outlet and compensated for in a particularly advantageous manner. A sander with a particularly high level of handling comfort can be provided in an advantageous manner. For example, the sander center of gravity and the battery pack center of gravity are located on different sides of the main extension plane of the bow-shaped handle. The dust outlet is located in particular on the drive housing, preferably on the fan housing. The dust outlet is arranged in particular on one side of the separating plane, the main extension plane of the bow-shaped handle, and/or the main extension plane of the handle housing. Preferably, the handheld power tool system comprises a dust collection container, e.g. a dust box, a dust bag, or the like. An overall center of gravity of the handheld power tool system relates in particular to the handheld power tool, preferably the sander comprising the battery pack and preferably has no dust collection container and/or protective device. Preferably, the dust collection container can be attached to the dust outlet, in particular detachably, e.g. by means of a screw connection, a latching connection, or the like. Alternatively, it is also conceivable that at least one dust outlet connecting piece of the dust collection container is designed to be integral with the dust outlet. Preferably, the dust collection container is rotatably mounted on the dust outlet. Alternatively, however, it is also conceivable that the dust collection container can be connected to the dust outlet in a rotationally fixed manner. The dust collection container is in particular intended to collect dust and/or debris, preferably extracted by the extraction fan. Alternatively or additionally, it is conceivable that the dust outlet can be coupled to an active extraction device, e.g. a vacuum cleaner, particularly in the case of a handheld power tool that is designed without an extraction fan. It is also conceivable that the dust collection container can be compressed by contact with the work surface when the handheld power tool is put in the placement and/or storage position, in particular to enable the handheld power tool to be put in the placement and/or storage position. Alternatively or additionally, it is also conceivable that the dust collection container can be displaced in the direction of the dust outlet, in particular displaced relative to the dust outlet via contact with the work surface when the handheld power tool is in the placement and/or storage position.

It is further proposed that a ratio between a minimum distance between the battery pack center of gravity when arranged on the sander and the drive axis of the drive unit and the maximum longitudinal extent of the tool holder is at least 0.85 and at most 1.2. Advantageously, a particularly favorable weight distribution can be achieved with regard to handling and/or guiding the handheld power tool. A particularly high level of operating convenience can be achieved. The minimum distance between the battery pack center of gravity when arranged on the sander and the drive axis extends in particular at least substantially parallel to the tool holder surface, the main extension plane of the bow-shaped handle, the main extension plane of the handle housing, and/or the separating plane. The minimum distance between the battery pack center of gravity when arranged on the sander and the drive axis is at least substantially perpendicular to the drive axis. By way of example, the minimum distance between the battery pack center of gravity and the drive axis is at least substantially 136 mm for a battery pack with 4 Ah electrical charge capacity, at least substantially 148 mm for a battery pack with 8 Ah electrical charge capacity and at least substantially 160 mm for a battery pack with 12 Ah electrical charge capacity. Alternatively, however, other values for the minimum distance between the battery pack center of gravity and the drive axis are also conceivable, in particular depending on the weight of the battery pack.

It is further proposed that an overall center of gravity of the handheld power tool system, in particular the one specified hereinabove, is arranged in the handle recess of the bow-shaped handle. A particularly high level of comfort can be achieved when handling handheld power tools. A particularly favorable weight distribution can be achieved in an advantageous manner. A minimum distance of the overall center of gravity from the separating plane of the handle housing, from the main extension plane of the handle housing, and/or from the main extension plane of the bow-shaped handle is preferably smaller than the maximum transverse extent of the handle housing, in particular of the bow-shaped handle, starting from the separating plane of the handle housing, the main extension plane of the handle housing, and/or the main extension plane of the bow-shaped handle. Preferably, the overall center of gravity is arranged in the separating plane of the handle housing, in the main extension plane of the handle housing, and/or in the main extension plane of the bow-shaped handle. Preferably, the overall center of gravity of the handheld power tool system is arranged at least with a battery pack with a single-layer battery cell arrangement within the handle recess of the bow-shaped handle. Preferably, the position of the overall center of gravity of the handheld power tool system comprising a battery pack with a single-layer battery cell arrangement is such that the handheld power tool can be placed on the tool holder, in particular without tilting. A minimum distance between the drive axis and the overall center of gravity has a value of at least 55 mm to at least 70 mm, in particular depending on the weight of the battery pack. The minimum distance between the drive axis and the overall center of gravity has a value of at most 65 mm to at most 75 mm, depending in particular on the weight of the battery pack. A maximum distance of the tool holder to the overall center of gravity in the direction of the drive axis has a value of at least 45 mm to at least 50 mm, in particular depending on the weight of the battery pack. The maximum distance between the tool holder and the overall center of gravity in the direction of the drive axis has a value of at most 52 mm to at most 55 mm, depending in particular on the weight of the battery pack.

It is further proposed that a ratio of the minimum distance between the battery pack center of gravity when arranged on the sander and the drive axis of the drive unit to the maximum longitudinal extent of the handle recess of the bow-shaped handle is at least 2.0 and at most 3.0. Advantageously, particularly precise and/or controlled handling of the sander can be achieved in an advantageous manner. Particularly safe and/or precise working with the sander can be achieved in an advantageous manner. A handheld power tool system with particularly favorable ergonomic properties can be provided in an advantageous manner.

It is also proposed that the handle housing at least partially covers the center bar on both sides in directions perpendicular to the main extension plane of the handle housing. A particularly large gripping surface can be provided for the operator in an advantageous manner. The operator can be prevented from coming into contact with the drive housing when using the handheld power tool device. A particularly high level of operating convenience can be achieved in an advantageous manner. The handle housing covers the center bar on both sides in the directions perpendicular to the main extension plane of the handle housing, in particular at a height of at least 10%, preferably at least 20%, and preferably at least 30%. The center bar is not covered by the handle housing, particularly in the longitudinal direction. It is also conceivable that the handle housing largely covers the center bar on both sides at a height in the directions perpendicular to the main extension plane of the handle housing, in particular at least 50%, preferably at least 70%, and preferably at least 90%.

It is also proposed that an end of the handle housing facing the center bar, preferably the end already specified hereinabove, in particular an end surrounding the drive housing in a substantially ring-like manner, is arranged at a distance from the drive housing, in particular at a radial and axial distance, preferably with respect to the drive axis. A particularly large grip region can be made provided to the operator in an advantageous manner. The operator can be prevented from coming into contact with the drive housing when using the handheld power tool device. A particularly high level of operating convenience can be achieved in an advantageous manner. Preferably, the end is arranged at a distance from the surface. Preferably, the end surrounds the motor housing of the drive housing like a ring. In particular, the motor housing is arranged on the center bar. The motor housing is preferably arranged on a side of the center bar facing away from the tool holder, in particular above the center bar with respect to the tool holder. The motor housing is preferably enclosed by the handle housing in a plane perpendicular to the drive axis. Preferably, the motor housing is at least substantially completely enclosed by the handle housing in the radial direction starting from the drive axis. The phrase “at least substantially complete” can be understood at least 50%, preferably at least 75%, and particularly preferably at least 90% of a total volume and/or a total mass of an object. Preferably, the motor housing is designed to be at least partially integral with the center bar. The term “at least one unit or object and at least one further unit or object are designed to be at least partially integral with one another” is in particular understood to mean that at least one element of the unit or object is designed to be integral with at least one further element of the further unit or object. The term “integral” can be understood to mean at least connected in a bonded manner, e.g. by a welding process, a soldering process, a bonding process, an injection molding process, and/or another process that a skilled person considers useful, and/or advantageously designed in one piece, e.g. by production from a casting and/or by production in a single or multi-component injection molding process and advantageously from a single blank. The handle housing, in particular the end of the handle housing, is preferably arranged at a distance from the drive housing, in particular the motor housing.

It is further proposed that the end of the handle housing facing the center bar is adapted to the shape of the drive housing, in particular the center bar and/or the surface. A particularly large gripping surface for an operator can be achieved in an advantageous manner, along with a particularly small space requirement. Preferably, said end comprises two recesses for the center bar. It is conceivable that the end is at a constant distance from the drive housing in the direction of the drive axis. Alternatively, however, it is also conceivable that the distance between the end and the drive housing varies in the direction of the drive axis.

It is also proposed that the center bar comprises a holder for an operator interface and/or a communication module. A particularly space-saving arrangement of an operator interface can be achieved in an advantageous manner. The functionality of the handheld power tool device can be extended to save space in an advantageous manner. Particularly protected and secure positioning of an operator interface can be achieved in an advantageous manner. The holder is preferably designed as a recess in the center bar. The operator interface comprises, e.g., one or multiple input elements. The input element of the operator interface can, e.g., be designed as a button, a rotary wheel, a switch, or the like. For example, the handheld power tool can be switched on and/or off via the operator interface, in particular via the at least one input element of the operator interface, and/or a rotational speed of the handheld power tool, preferably the sander, can be adjusted or the like. It is conceivable that the operator interface comprises one or multiple output elements, e.g. a display, a light element, in particular an LED, or the like. For example, the operator interface, in particular the at least one output element, can be used to output the rotational speed of the handheld power tool, preferably the sander, a charge status of the battery pack, a device status of the handheld power tool, or the like. Preferably, the operator interface is connected via data technology to a control unit of the handheld power tool, in particular the sander, preferably by in a wired and/or wireless manner. The control unit is intended in particular for controlling the drive unit. In particular, the control unit comprises at least one processor and one memory element, as well as an operating program stored on the memory element. The memory element is preferably designed as a digital storage medium, e.g. a hard disk or the like. The holder is preferably arranged on a side of the motor housing facing away from the bow-shaped handle. In particular, the holder is arranged on a side of the handle housing facing away from the battery pack interface of the handheld power tool. In particular, the communication module is configured to communicate with another device, e.g. a smartphone, a laptop, a server, a cloud, a gateway, or the like. Preferably, the communication module is connected to the control unit and/or the operator interface using data technology, in particular in a wireless and/or by wired manner. It is conceivable that the communication module is a portion of the operator interface. Alternatively, however, it is also conceivable that the communication module is designed and/or arranged to be separate from the operator interface. For example, it is conceivable that the communication module is arranged in the handle housing, in particular in the bow-shaped handle. It is also conceivable that the communication module is a portion of the control unit. The communication module can comprise one or multiple data transmission technologies, e.g. Bluetooth, NFC, or the like. The control unit is preferably located in the handle housing.

In one aspect of the invention, which can in particular be considered independently of further aspects of the invention, it is proposed that the drive housing comprises at least one air outlet opening which is at least partially covered by the handle housing, in particular when viewed at least in a main outlet direction of the air outlet opening. A particularly favorable exhaust air flow can be achieved in an advantageous manner. Advantageously, the operator can be protected from exhaust air particularly efficiently and/or in a structurally simple manner. A particularly high level of operating convenience can be achieved in an advantageous manner. Preferably, the air outlet opening is at least partially covered by the handle housing, at least when viewed in a plane perpendicular to the drive axis. It is conceivable that the handle housing covers at least most of the air outlet opening, preferably at least 50%, preferably at least 75% and particularly preferably at least 90%, in particular when viewed in a plane perpendicular to the drive axis. It is also conceivable that the handle housing completely covers the air outlet opening, particularly when viewed in a plane perpendicular to the drive axis. The main outlet direction is determined by the arrangement and/or geometry of the air outlet opening. For example, the main outlet direction extends at least substantially perpendicular to the drive axis and/or at an angle to the drive axis, preferably inclined in the direction of the tool holder. The air outlet opening is preferably covered by the end of the handle housing, in particular when viewed in a plane perpendicular to the drive axis. Preferably, the air outlet opening is arranged above the center bar, preferably in relation to the tool holder and/or the surface.

It is further proposed that the drive housing comprises a motor housing, in particular the motor housing specified hereinabove, which is arranged on the center bar and comprises the air outlet opening. The hot engine exhaust air can be efficiently dissipated while at the same time providing particularly efficient protection for the operator from the engine exhaust air in an advantageous manner. A handheld power tool device with a particularly high level of operating convenience can be provided. The motor housing preferably comprises a plurality of air outlet openings. The air outlet openings are, e.g., arranged at a distance from each other in a circumferential direction, which in particular extends in a plane perpendicular to the drive axis.

It is also proposed that an opening is formed between the end of the handle housing facing the center bar and the drive housing to allow air to escape from the air outlet opening. The hot engine exhaust air can be efficiently dissipated while at the same time providing particularly efficient protection for the operator from the engine exhaust air in an advantageous manner. A handheld power tool device with a particularly high level of operating convenience can be provided. The opening is preferably arranged opposite the upper side. The opening is in particular formed by arranging the end of the handle housing at a distance from the drive housing, preferably the motor housing.

In one aspect of the invention, which can in particular be considered independently of further aspects of the invention, it is proposed that the drive housing comprises a closed cable channel. Efficient protection for a cable connection can be advantageously provided. A particularly space-saving and/or protected arrangement of a cable connection can be achieved in an advantageous manner. It is conceivable that at least a part, in particular a large part, preferably at least 50%, preferably at least 70%, of the cable channel is enclosed by the handle housing, in particular when viewed in a plane perpendicular to the drive axis. An open end of the cable channel is preferably arranged on the holder. A further open end of the cable channel is preferably arranged in an inner region of the handle housing. In particular, the cable channel extends from the holder to the inside of the handle housing. The cable channel extends over the entire motor housing, for example, particularly in the direction of the drive axis. Preferably, the handheld power tool, in particular the sander and/or the handheld power tool device comprises an electrical connection unit. In particular, the electrical connection unit comprises at least one electrical connection element, e.g. a cable. The electrical connection unit, in particular the electrical connection element, is preferably intended to connect the operator interface to the control unit, in particular at least in terms of data technology and/or control technology. Preferably, the operator interface can be supplied with electrical energy via the electrical connection unit, preferably via the at least one electrical connection element and/or a further electrical connection element of the electrical connection unit. The electrical connection unit, in particular the at least one electrical connection element and/or the further electrical connection element, is/are arranged in the cable channel. The holder preferably comprises at least one electrical connection for the operator interface and/or the communication interface. At least the electrical connection element and/or the further electrical connection element is/are connected to the connection.

It is also proposed that the drive housing comprises at least two housing shells, between which the cable channel is arranged. Advantageously, it is particularly easy to install a cable connection in the cable channel. Advantageously, a closed cable channel can be provided in a simple design and, in particular, with a particularly high level of convenience when installing a cable connection. In particular, the drive housing has a shell design, with the two housing shells acting as half shells. The two housing shells of the drive housing are preferably connected to each other in a drive housing separating plane of the drive housing. The drive housing separating plane preferably extends at least substantially parallel to the separating plane of the handle housing. It is conceivable that the drive housing separating plane corresponds to the separating plane of the handle housing. Alternatively, however, it is also conceivable that the drive housing separating plane extends at an angle to the separating plane. Preferably, the cable channel extends inside the outer walls of the housing shells, in particular inside at least one outer wall of one of the housing shells. Preferably, the cable channel connects to a contact surface of the outer walls of the two housing shells.

It is also proposed that one housing shell of the housing shells forms a groove for the cable channel and another housing shell of the housing shells forms a cover for the cable channel. A closed cable channel with a simple design can be provided in a structurally advantageous manner.

It is further proposed that the cable channel is arranged at least partially on, in particular in, the center bar. A closed cable channel can be achieved in a particularly space-saving and advantageous manner. It is conceivable that at least a portion of the cable channel extends through the center bar, e.g. at least 5%, 10%, or 20% of the cable channel.

Further proposed in particular is a handheld power tool, in particular the handheld sander specified hereinabove, preferably the sander specified hereinabove comprising the handheld power tool device. A handheld power tool with a particularly low overall height can be provided in an advantageous manner. A handheld power tool with particularly favorable handling characteristics, in particular a particularly large gripping surface for the operator, can be provided.

It is also proposed that the sander comprises a tool holder, in particular the tool holder specified hereinabove for holding a tool, in particular the tool specified hereinabove, whereby the tool holder and/or the tool are/is at a distance from the work surface in the at least one placement and/or storage position. Advantageously, an excessive load on the tool holder and/or the tool in the at least one placement and/or storage position of the sander can be counteracted. Damage to the tool holder and/or the tool, in particular by the work surface, can be counteracted. It is possible to conveniently replace the tool. A particularly high level of operating convenience can be achieved, in particular when replacing tools and/or performing maintenance work or the like on the tool holder.

It is further proposed that the sander can be placed in the at least one placement and/or storage position solely via the support surface. It is advantageous to counteract the formation of signs of wear caused by contact between the sander, in particular the housing unit, and the work surface. The sander can be placed particularly gently in an advantageous manner. Preferably, the sander is at a distance from the work surface in the at least one placement and/or storage position. In particular, the sander is connected to the work surface via the battery pack in the at least one placement and/or storage position, and can preferably be placed on the work surface. In the at least one placement and/or storage position, only the support surface on the battery pack is in contact with the work surface.

It is further proposed that a main extension plane of the supporting surface extends at an angle other than 90° to a main extension plane of the tool holder surface of the tool holder of the sander. Advantageously, a particularly favorable weight distribution can be achieved when placing the sander down. Particularly safe placement of the sander can be achieved in an advantageous manner. By tilting the tool holder surface in this way, the tool can be mounted and removed particularly conveniently in the placement and/or storage position of the sander. A particularly high level of operator comfort can be achieved in an advantageous manner. In particular, a main extension axis of the handheld power tool, in particular the sander, extends at an angle other than 90° to the main extension plane of the support surface. It is conceivable that the tool holder surface extends at least substantially parallel to the main extension axis of the handheld power tool, in particular the sander. In particular, a handle axis of the handle housing extends at an angle other than 90° to the main extension plane of the support surface in the placement and/or storage position. The handle axis is defined in particular by the bow-shaped handle. The handle axis preferably extends in the separating plane and/or in the main extension plane of the handle housing, in particular in the main extension plane of the bow-shaped handle. The handle axis corresponds in particular to a main extension axis of a handle tube of the bow-shaped handle.

It is also proposed that the main extension plane of the tool holder surface and the main extension plane of the supporting surface include an angle which is greater than 80°. Advantageously, the sander can be placed in a particularly safe and space-saving manner. Preferably, the angle enclosed by the main extension plane of the tool holder surface and the main extension plane of the supporting surface has a value of less than 90° and greater than 80°. In particular, the tool holder, preferably the tool holder surface, is inclined in a direction away from the work surface in the placement and/or storage position. Particularly preferably, the angle enclosed by the main extension plane of the tool holder surface and the main extension plane of the supporting surface has a value of at least substantially 86°.

It is further proposed that a normal of the main extension plane of the support surface intersects the battery pack and sander center of gravity. Advantageously, the sander can be placed in a particularly stable manner. Preferably, the normal of the main extension plane of the support surface intersects a geometric center of the support surface and/or the battery pack center of gravity, in particular at least a nearby region of the geometric center of the support surface and/or a nearby region of the battery pack center of gravity. In this context, the term “nearby region” is in particular context understood to mean a range that is at a maximum distance from a reference point that is preferably less than 7%, preferably less than 5%, of a maximum longitudinal extent of the battery pack.

It is also proposed that one edge of the battery pack housing of the battery pack forms the support surface. Advantageously, the sander can be placed on the base in a particularly stable manner. Preferably, an edge of the battery pack housing facing away from the tool holder forms the support surface. Preferably, the support surface and a support point of the sander span a support plane of a (in particular further) placement and/or storage position of the support unit.

It is also proposed that a main extension axis of the battery pack extends at least substantially perpendicular to the main extension axis of the sander. Advantageously, the sander can be placed on the work surface in a particularly stable manner. Preferably, the edge of the battery pack housing extends at least substantially perpendicular to the main extension axis of the handheld power tool.

It is further proposed that the sander comprises only one support point, in particular the one specified hereinabove, which comes to rest in a support plane, in particular the one specified hereinabove, of an particular further placement and/or storage position of the support unit, in particular the one specified hereinabove. Advantageously, wear of the sander, in particular the housing unit, due to contact with the work surface can be minimized, in particular at a particularly high level of stability when the sander is set down. The support point is preferably located on the handle housing or the drive housing. The support point is preferably located on a surface of the palm grip. The palm grip preferably has a round shape. The surface of the palm grip, on which the support point is arranged, is preferably curved. Alternatively, however, it is also conceivable that the surface of the palm grip on which the support point is arranged is flat. The support point of the sander is preferably arranged on a side of the handle housing facing away from the tool holder. Alternatively, however, it is also conceivable that at least one support elevation is arranged on the palm grip, which comes to rest in the support plane of the at least one, in particular further placement and/or storage position. The at least one support elevation is intended in particular to form a support line for placement of the handheld power tool. The support elevation is, e.g., designed as an elongated bar whose main extension axis extends at least substantially perpendicular to the main extension axis of the handheld power tool, to the separating plane, to the main extension plane of the bow-shaped handle, and/or to the main extension plane of the handle housing. Furthermore, it is also conceivable that the palm grip comprises at least two support elevations, preferably in a direction perpendicular to the separating plane, which are at a distance from each other and designed as humps or the like and which are preferably situated in the support plane of the at least one, in particular further placement and/or storage position. Given a design having at least one raised support on the palm grip, it is feasible to place the handheld power tool without the battery pack in an additional placement and/or storage position, whereby the handheld power tool can be placed on the work surface via the at least one raised support on the palm grip and a further support point on the handle housing, in particular in a region of the battery pack interface. Additionally or alternatively, it is also feasible for at least one raised support to be arranged on the handle housing, in particular in the region of the battery pack interface.

It is further proposed that the support unit is designed for placing and/or storing the sander on the work surface in at least one, in particular the further placement and/or storage position specified hereinabove, whereby the battery pack comprises a further support surface of the support unit for the further placement and/or storage position. Advantageously, a particularly high degree of flexibility can be achieved while safely placing the sander on a work surface. For example, the edge of the battery pack forms the additional support surface of the support unit for the additional placement and/or storage position. In the further placement and/or storage position, the tool holder surface preferably extends at least substantially parallel to a support plane of the further placement and/or storage position. In the further placement and/or storage position, the drive axis extends in particular at least substantially perpendicular to the support plane of the further placement and/or storage position. In the further placement and/or storage position, the further support surface and the support point of the sander in particular come to lie in the support plane of the further placement and/or storage position. The handheld power tool system is preferably in contact with the work surface in the further placement and/or storage position via the further support surface on the battery pack and the support point on the sander.

It is further proposed that the shutter unit is intended to block a light emission from at least one light source, at least in the direction of an intended operator side. Advantageously, an operator can be prevented from being blinded when working with the safety guard. It can enable particularly safe and/or comfortable working with the protective device. In particular, the shutter unit is intended to block the light emission of the at least one light source in a direction away from the tool holder. The operator side corresponds in particular to a position of the operator in relation to the handheld power tool, in particular the light source, which the operator assumes when working on a workpiece.

In one aspect of the invention, which can in particular be considered independently of further aspects of the invention, it is proposed that the protective device comprises a light source unit. A workpiece can be illuminated with particular precision during processing in an advantageous manner. Advantageously, the light source unit is particularly easy to maintain and/or replace. A particularly high level of operating convenience can be achieved. The light source unit preferably comprises at least one light source, e.g. the light source or multiple light sources specified hereinabove. The light source unit, in particular the at least one light source, is preferably arranged on the base body, the shutter unit, or the light guide unit.

In one aspect of the invention, which can in particular be considered independently of further aspects of the invention, it is proposed that the protective device comprises at least one energy source and/or at least one operating element for at least one light source, in particular the one specified hereinabove. The functionality of the protective device can be advantageously extended. Such a design of the protective device enables particularly comfortable working. The energy source can be in the form of a battery, rechargeable battery, or the like. The energy source is particular intended for supplying energy to the light source, preferably the light source unit. Preferably, the energy source is connected to the light source, in particular the light source unit, at least in one operating state. Alternatively or additionally, however, it is also conceivable that the light source, preferably the light source unit, can be supplied with electrical energy via the handheld power tool, in particular the sander, e.g. via an electrical plug connection between the protective device and the handheld power tool. The at least one operating element of the protective device is preferably arranged on the base body. The at least one operating element of the protective device can, e.g., be designed as a button, a rotary wheel, a switch, or the like. The at least one light source can, e.g., be switched on and/or off and/or an illumination parameter, such as a light color, intensity or the like, can be adjusted via the at least one control element of the protective device.

In one aspect of the invention, which can in particular be considered independently of further aspects of the invention, it is proposed that the protective device comprises a sensor unit for detecting operation of the handheld power tool, in particular for activating at least one light source, in particular the light source unit specified hereinabove, preferably the light source unit, during operation of the handheld power tool. Advantageously, activation of the at least one light source can be automated in an advantageous manner. A particularly high level of operator comfort can be achieved in an advantageous manner. The sensor unit is preferably arranged on the base body, on the shutter unit, or on the light guide unit. The sensor unit preferably comprises at least one sensor element, e.g. a vibration sensor or the like, for detecting operation of the handheld power tool. The sensor unit preferably comprises control electronics for processing the sensor signals. The control electronics are preferably connected to the at least one light source, in particular the light source unit, for control purposes. In particular, the control electronics are intended to switch on the light source when operation of the handheld power tool is detected. It is conceivable that the control electronics are a portion of the control unit of the handheld power tool. Alternatively, however, it is also conceivable that the control electronics are designed separately from the control unit.

In one aspect of the invention, which can in particular be considered independently of further aspects of the invention, it is proposed that the protective device is at least partially made of a thermoplastic elastomer, in particular comprising a protective layer consisting of at least partially of a thermoplastic elastomer. A particularly high level of impact protection can be achieved in an advantageous manner. A particularly durable protective device can be provided. Preferably, the base body of the protective device is at least partially made of a thermoplastic elastomer. Preferably, at least one surface of the protective device facing away from the handheld power tool, in particular the base body, is made of a thermoplastic elastomer. The protective layer can be a cover placed over the base body, a layer glued to the base body, or the like. Alternatively or additionally, it is also conceivable that the protective layer is clamped, screwed, or the like onto the base body. It is also conceivable that the protective layer is injection-molded around the base body, in particular that the protective layer is injection-molded onto the base body, e.g. in a two-component injection molding process.

In one aspect of the invention, which can in particular be considered independently of further aspects of the invention, it is proposed that the protective device comprises a fastening unit for detachable fastening to the handheld power tool with at least two fixing rails which extend parallel to one another and comprise at least two latching recesses. Robust attachment of the protective device to the handheld power tool is easy to implement in an advantageous manner. The handheld power tool, in particular the drive housing, preferably the fan housing, comprises in particular a protective fastening unit corresponding to the fastening unit. The protective fastening unit comprises, e.g., at least one fixing rail. The fixing rail of the protective fastening unit is arranged between the fixing rails of the fastening unit, in particular in a state of the protective device, in particular the base body, arranged on the handheld power tool. The fixing rails of the fastening unit and the fixing rail of the protective fastening unit are preferably intended for fixing in an axial direction relative to one another, preferably with respect to the drive axis. The protective fastening unit preferably comprises two latching elements, in particular latching hooks or the like. In particular, the latching elements are intended to interact with the latching recesses of the fastening unit to fasten the protective device, in particular the base body, to the handheld power tool. Alternatively, it is also conceivable that the design of the fastening unit and the protective fastening unit are interchanged.

In one aspect of the invention, which can in particular be considered independently of further aspects of the invention, it is proposed that the protective device has an asymmetrical basic shape, in particular adapted to a dust outlet of the handheld power tool, in particular the dust outlet specified hereinabove. In particular, a shape of the base body deviates from a circular shape along its longitudinal extent in at least one section, preferably in a region of the dust outlet.

Further proposed is a handheld power tool system, in particular the one specified hereinabove, in particular comprising the handheld power tool and protective device specified hereinabove. Particularly efficient and/or precise illumination of a workpiece to be processed by the handheld power tool can be achieved. Such a design of the protective device can counteract blinding of the operator. Advantageously, a particularly high level of operating comfort and/or safety can be achieved.

In addition, the invention is based on a method for manufacturing a protective device, in particular the protective device specified hereinabove. It is proposed that the protective device be made at least partially of a thermoplastic elastomer. A particularly durable protective device can be provided in an advantageous manner. Particularly efficient impact protection can be achieved in an advantageous manner. Preferably, the base body is made at least partially of a thermoplastic elastomer, e.g. in a single or multi-component injection molding process.

It is further proposed that the handheld power tool device comprises a tool holder, in particular the tool holder specified hereinabove for holding a tool, in particular the tool specified hereinabove, in particular a sanding means, whereby a maximum distance of the extension arm from the drive axis is greater than a maximum distance of the tool holder from the drive axis, in particular when viewed in the separating plane of the handle housing.

A particularly wide support of the drive housing on the handle housing can be advantageously achieved. Advantageously, a particularly high level of stability can be achieved when guiding the handheld power tool, in particular the handheld power tool device. Advantageously, particularly precise work can be enabled using the handheld power tool. Preferably, a maximum distance of the portion of the damping unit on the extension arm to the drive axis is greater than the maximum distance of the tool holder to the drive axis, in particular when viewed in the separating plane of the handle housing.

It is further proposed that a ratio of a maximum transverse extent of the portion of the damping unit to a minimum distance of the portion of the damping unit from the handle axis of the handle housing is at least 0.9 and at most 1.05. Advantageously, torques around the handle axis can be supported particularly efficiently. A particularly high level of stability can be achieved in an advantageous manner. Particularly precise work can be achieved by the handheld power tool device. The maximum transverse extent of the portion of the damping unit extends in particular at least substantially perpendicular to the main extension plane of the handle housing, preferably the main extension plane of the bow-shaped handle and/or the separating plane. The maximum transverse extent of the portion of the damping unit preferably extends at least substantially parallel to the tool holder surface. The minimum distance of the portion of the damping unit from the handle axis is preferably measured parallel to the separating plane, in particular to the main extension plane of the bow-shaped handle, preferably the main extension plane of the handle housing. The maximum transverse extent of the portion of the damping unit is preferably at least 40 mm, preferably at least 45 mm. The maximum transverse extent of the portion of the damping unit is preferably no more than 60 mm, preferably no more than 50 mm. The ratio between the maximum transverse extent of the portion of the damping unit and the maximum height of the sander is preferably at most 0.35, preferably at most 0.4. The ratio between the maximum transverse extent of the portion of the damping unit and the maximum height of the sander is preferably at most 0.5, preferably at most 0.45. The minimum distance between the portion of the damping unit and the handle axis is preferably at least 45 mm, preferably at least 50 mm. The minimum distance between the portion of the damping unit and the handle axis is preferably at most 60 mm, preferably at most 55 mm. Alternatively, however, it is also conceivable that the minimum distance between the portion of the damping unit and the handle axis is less than 45 mm or greater than 60 mm.

It is also proposed that a ratio between the maximum transverse extent of the portion of the damping unit and a minimum distance of the portion of the damping unit from the drive axis is at least 0.7, preferably at least 0.73, and at most 0.8, preferably at most 0.77. Advantageously, tipping forces can be supported particularly efficiently. A particularly stable handheld power tool device can be provided. The minimum distance of the portion of the damping unit to the drive axis is preferably measured parallel to the separating plane, in particular to the main extension plane of the bow-shaped handle, preferably the main extension plane of the handle housing. The minimum distance between the portion of the damping unit and the drive axis is preferably at least 55 mm, preferably at least 60 mm. The minimum distance between the portion of the damping unit and the drive axis is preferably no more than 70 mm, preferably no more than 65 mm. Alternatively, however, it is also conceivable that the minimum distance between the portion of the damping unit and the drive axis is less than 55 mm or greater than 70 mm.

It is further proposed that a ratio of a maximum height of the housing unit to the minimum distance of the portion of the damping unit on the extension arm from the handle axis of the handle housing is at most 2.25. A particularly wide support of the drive housing on the handle housing can be achieved. Advantageously, a particularly high level of stability can be achieved when handling the handheld power tool, in particular the sander. The maximum height of the housing unit preferably extends in the separating plane, in particular in the main extension plane of the handle housing, preferably in the main extension plane of the bow-shaped handle. The maximum height of the housing unit extends parallel to the drive axis in particular. The maximum height of the housing unit is preferably at least 90 mm, preferably at least 100 mm. The maximum height of the housing unit is preferably at most 120 mm, preferably at most 110 mm. Alternatively, however, it is also conceivable that the maximum height of the housing unit in the direction of the drive axis is less than 90 mm or greater than 120 mm. A ratio of a maximum extent of the damping unit, in particular a maximum distance between the damping elements, in the direction of the drive axis to the maximum height of the housing unit is preferably at least 0.8, preferably at least 0.85. A ratio of the maximum extent of the damping unit, in particular a maximum distance between the damping elements, in the direction of the drive axis to the maximum height of the sander is preferably at least 0.7, preferably at least 0.75. The maximum extent of the damping unit, in particular the maximum distance between the damping elements in the direction of the drive axis, is preferably at least 85 mm, preferably at least 90 mm. Alternatively, however, it is also conceivable that the maximum extent of the damping unit, in particular the maximum distance between the damping elements in the direction of the drive axis, is less than 85 mm.

It is also proposed that a ratio of the minimum distance of the portion of the damping unit from the drive axis in a direction perpendicular to the drive axis to a maximum longitudinal extent of the housing unit is greater than 0.3. A particularly wide support of the drive housing on the handle housing can be achieved. Advantageously, a particularly high level of stability can be achieved when handling the handheld power tool, in particular the sander. The maximum longitudinal extent of the housing unit is preferably perpendicular to the drive axis. The maximum longitudinal extent of the housing unit preferably extends at least substantially parallel to the tool holder surface. The maximum longitudinal extent of the housing unit extends in particular in the separating plane, preferably in the main extension plane of the handle housing, in particular in the main extension plane of the bow-shaped handle. The maximum longitudinal extent of the housing unit is preferably at least 175 mm, preferably at least 180 mm. The maximum longitudinal extent of the housing unit is preferably no more than 190 mm, preferably no more than 185 mm. Alternatively, however, it is also conceivable that the maximum longitudinal extent of the housing unit is less than 175 mm or greater than 190 mm.

It is further proposed that a ratio of the minimum distance between the portion of the damping unit and the drive axis to the minimum distance between the portion of the damping unit and the handle axis of the handle housing is at least 1.2 and at most 1.3. A handheld power tool with a particularly favorable support of the drive housing on the handle housing can be provided.

It is further proposed that the handle housing comprises a bow-shaped handle, in particular the bow-shaped handle specified hereinabove, which is supported by the portion of the damping unit and/or the extension arm on the drive housing to form the closed handle recess of the bow-shaped handle. A particularly efficient support of the drive housing on the handle housing can be achieved along with simultaneous vibration decoupling of the handle housing from the drive housing. A particularly high level of handling stability can be achieved with a particularly high level of operating convenience.

It is also proposed that the portion of the damping unit and/or the extension arm is arranged in the direction of the handle axis at the height of the handle recess. Particularly broad support of the drive housing on the handle housing can be achieved. Advantageously, a handheld power tool device can be provided with particularly high stability and, at the same time, particularly efficient vibration decoupling. Preferably, the portion of the damping unit on the extension arm and/or the extension arms, viewed in the direction of the handle axis, is arranged at least substantially completely within the maximum longitudinal extent of the handle recess.

It is further proposed that the portion of the damping unit arranged on the extension arm comprises at least two damping elements arranged at a distance from each other. A particularly favorable ratio between stable support of the drive housing on the handle housing and vibration decoupling of the handle housing from the drive housing can be achieved in an advantageous manner. The damping elements are preferably arranged on opposite sides of the extension arm. Preferably, the damping elements are arranged on different sides of the separating plane, in particular the main extension plane of the handle housing, preferably the main extension plane of the bow-shaped handle. Preferably, the damping elements are arranged in mirror symmetry with respect to the separating plane, in particular the main extension plane of the handle housing, preferably the main extension plane of the bow-shaped handle. The extension arm preferably comprises two damping element holders for the two damping elements specified hereinabove, or the damping element holder is configured to hold the two damping elements.

It is also proposed that the housing unit comprises a fan housing, in particular the fan housing specified hereinabove for holding an extraction fan, in particular the extraction fan specified hereinabove, whereby the extension arm is arranged on the fan housing. A particularly wide support for the drive housing can be achieved in an advantageous manner. Particularly stable guidance of the handheld power tool, in particular the handheld power tool device, can be achieved with simultaneous vibration decoupling of the drive housing from the handle housing. In particular, the extraction fan is a portion of the handheld power tool, preferably the sander. Alternatively, it is also conceivable that the handheld power tool, in particular the sander, is designed without an extraction fan. Preferably, the extension arm is designed to be at least partially integral with the fan housing. The extension arm is arranged in particular on a side of the fan housing facing the battery pack interface. It is conceivable that the extension arm is, e.g., preferably arranged between two swing legs of the tool holder on a handheld power tool designed as an orbital sander, which comprises a rectangular tool holder. In particular, the swing legs are made of an elastic material, preferably plastic. The swing legs are preferably connected to the drive housing, in particular to the fan housing.

In one aspect of the invention, which can in particular be considered independently of further aspects of the invention, it is proposed that the drive housing comprises a motor housing, in particular the motor housing specified hereinabove for holding the drive unit and a fan housing, in particular the fan housing specified hereinabove for holding an extraction fan, in particular the extraction fan specified hereinabove, whereby the motor housing and the fan housing are designed to be at least partially integral with one another. A tolerance chain can be kept particularly low in an advantageous manner. A particularly high stability of the drive housing can be achieved. The fan housing and the motor housing comprise common housing shells, in particular the housing shells of the drive housing specified hereinabove. The two housing shells each comprise one half of the fan housing and one half of the motor housing.

In one aspect of the invention, which can in particular be considered independently of further aspects of the invention, it is proposed that the drive housing comprises a motor housing, in particular the motor housing specified hereinabove, on which at least one damping element of the damping unit is arranged such that the damping element is only partially enclosed by the handle housing when viewed in a sectional plane perpendicular to the drive axis through the damping element. Advantageously, the handle housing can be supported on the drive housing at a point on the handle housing that is particularly far outwards in the axial direction, in particular in relation to the drive axis. Particularly efficient support can be achieved with simultaneous vibration decoupling. A particularly high level of stability can be achieved when handling the handheld power tool, in particular the sander. Preferably, the sectional plane through the damping element only intersects a portion of the end of the handle housing facing the center bar, in particular due to the two recesses in the end for the center bar.

In one aspect of the invention, which can in particular be considered independently of further aspects of the invention, it is proposed that the damping unit comprises at least one sealing element, in particular a sealing ring, in order to block an inlet of exhaust air into the housing unit, in particular into the handle housing, whereby the sealing element, in particular the sealing ring, is arranged between the handle housing and the drive housing. Warm engine air can in an advantageous manner be prevented from flowing into the handle housing. Overheating of the handheld power tool, in particular the sander, can be counteracted. It is conceivable that the sealing element is arranged, in particular designed, as a closed sealing ring. The sealing element surrounds the motor housing in a circumferential direction, which in particular extends in a plane perpendicular to the drive axis, preferably at least substantially completely, in particular in an angular range of at least 270°, preferably at least 330°, preferably at least 350°, and particularly preferably completely. The sealing element preferably fills a gap between the motor housing and the handle housing at least substantially completely. The sealing element is preferably made of an elastic material, preferably an elastic plastic. Preferably, the material hardness of the sealing element preferably is different from the material hardness of the damping elements. The material hardness of the sealing element is preferably lower than the material hardness of the damping elements. Alternatively, it is conceivable that the sealing element and the damping elements have an identical material hardness. The sealing element is arranged above at least one air outlet in relation to the tool holder.

The handheld power tool, in particular the sander, the handheld power tool system, the protective device, the method, and/or the handheld power tool device are not intended to be limited to the application and embodiment described hereinabove. In particular, the handheld power tool, in particular the sander, the handheld power tool system, the method, and/or the handheld power tool device can/can comprise a number of individual elements, components, and units as well as method steps that deviates from a number specified herein in order to fulfill a mode of operation described herein. Moreover, regarding the ranges of values indicated in this disclosure, values lying within the limits specified hereinabove are also intended to be considered as disclosed and usable as desired.

### DRAWINGS

Further advantages follow from the description of the drawings hereinafter. Two exemplary embodiments of the invention are shown in the drawings. The drawings, the description, and the claims contain numerous features in combination. The skilled person will appropriately also consider the features individually and combine them into additional advantageous combinations.

### Shown are:

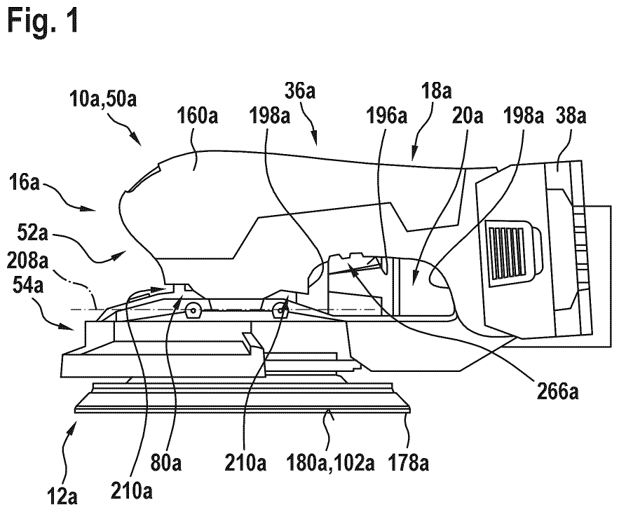

FIG. 1 a handheld power tool system comprising a handheld power tool in a side view,

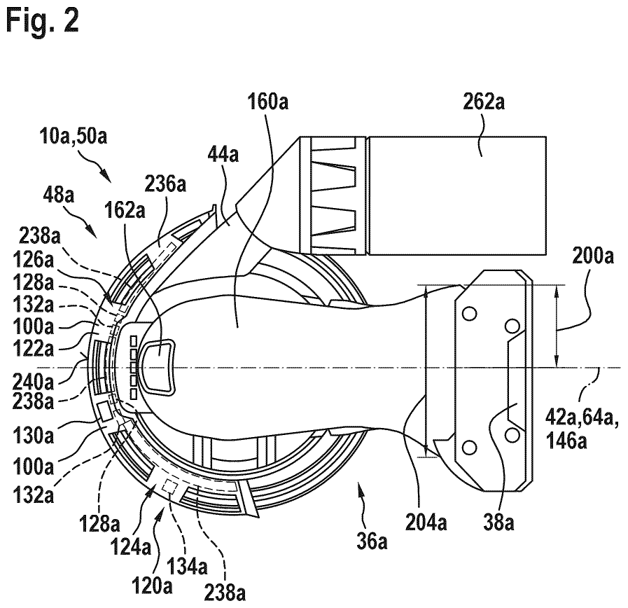

FIG. 2 the handheld power tool system in a plan view,

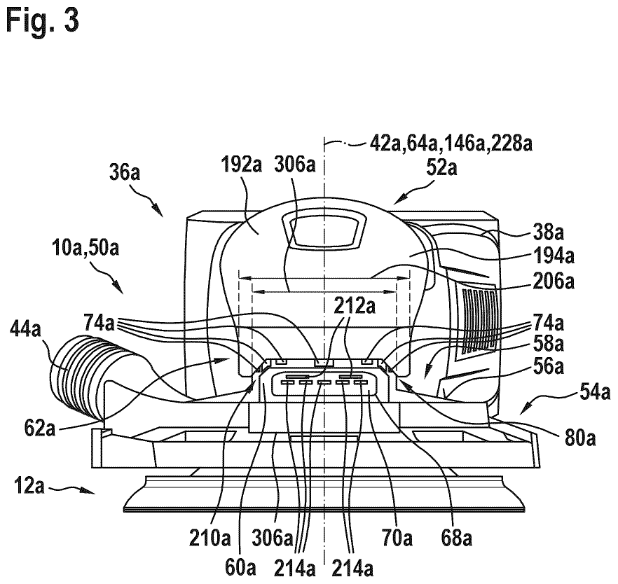

FIG. 3 the handheld power tool system in a front view,

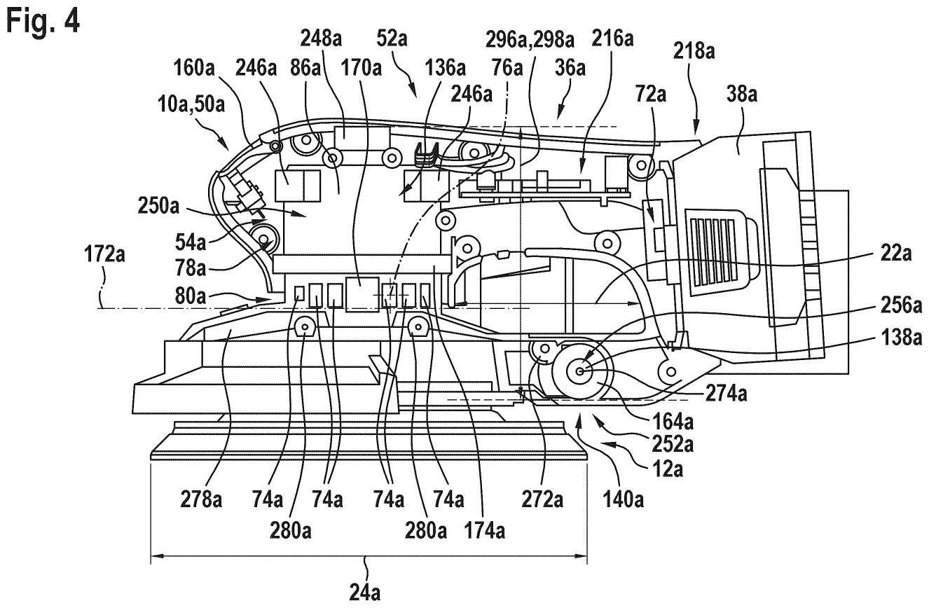

FIG. 4 the handheld power tool system in side view, comprising a handle housing shell,

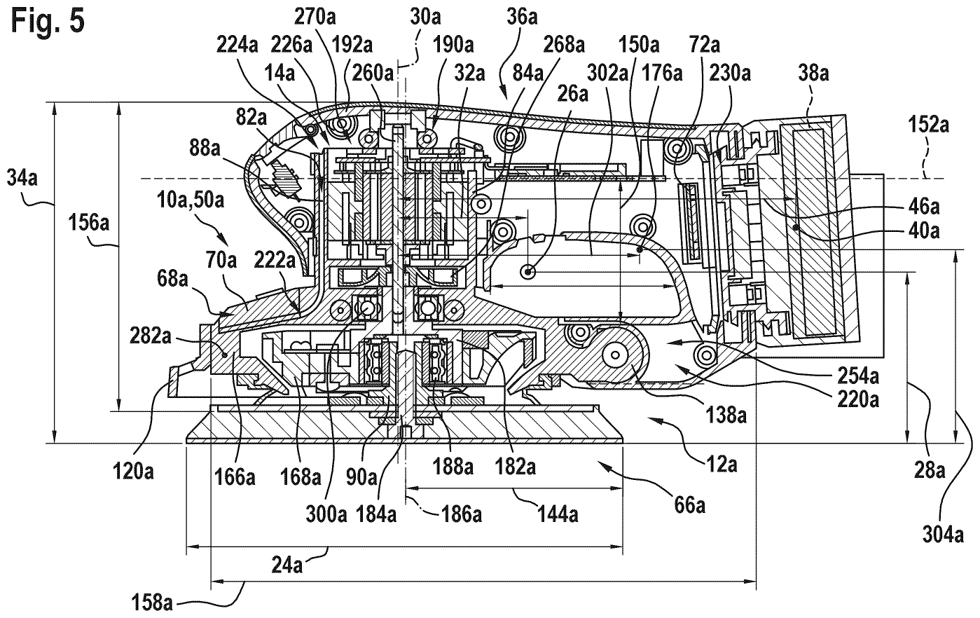

FIG. 5 the handheld power tool system in a cross-sectional view in a separating plane of a handle housing of the handheld power tool,

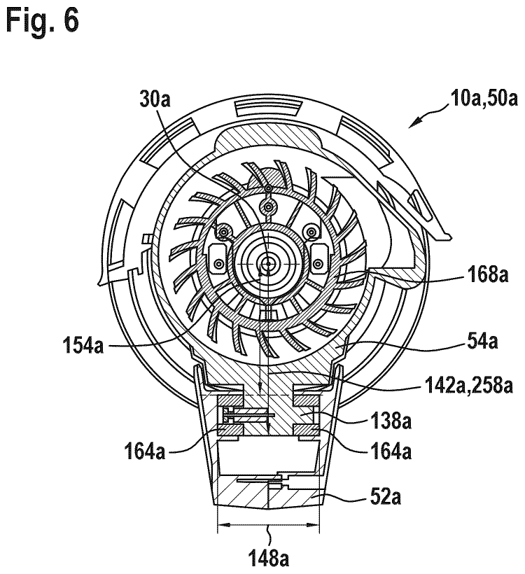

FIG. 6 a top view of the handheld power tool in a cross-sectional view,

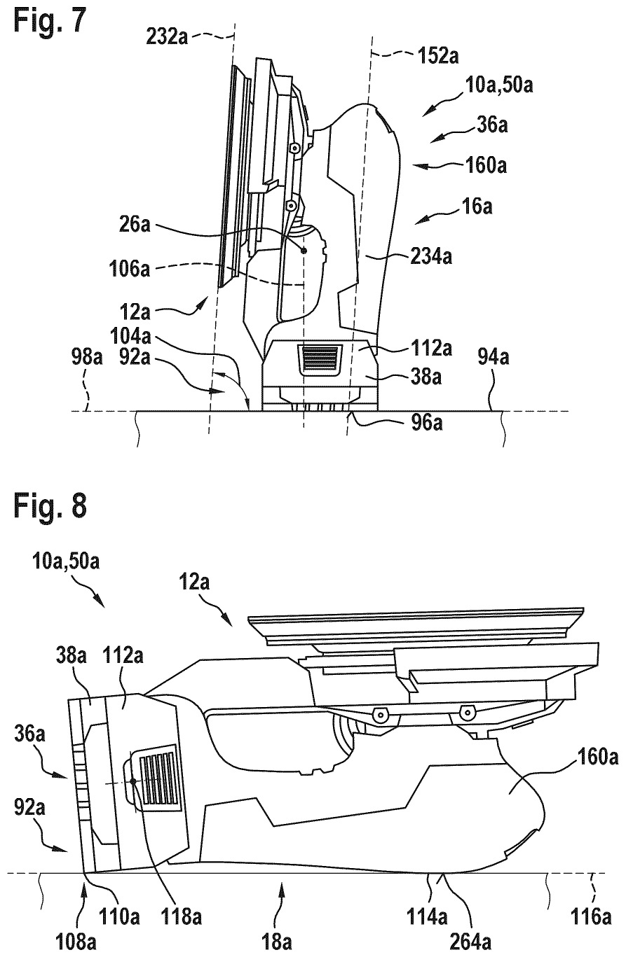

FIG. 7 the handheld power tool system in a placement and/or storage position on a work surface,

FIG. 8 the handheld power tool system in a further placement and/or storage position on the work surface,

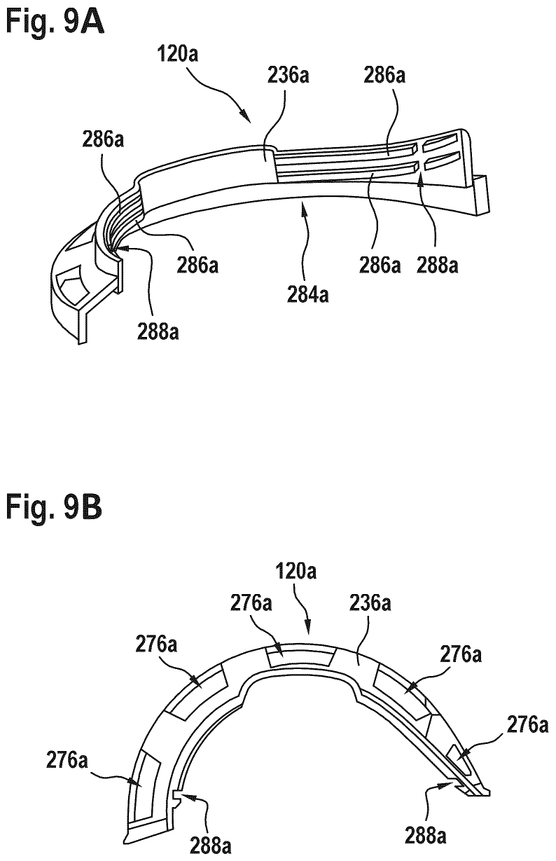

FIG. 9 a perspective view of a base body of a protective device of the handheld power tool system,

FIG. 9 the base body of the protective device in a plan view,

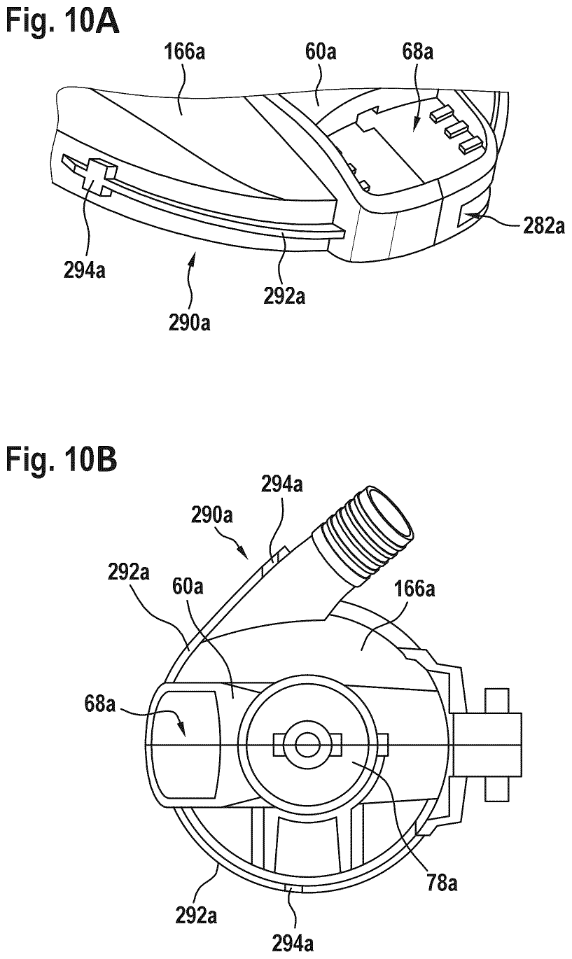

FIG. 10 a section of a drive housing of the handheld power tool in a perspective view,

FIG. 10b the drive housing in a plan view,

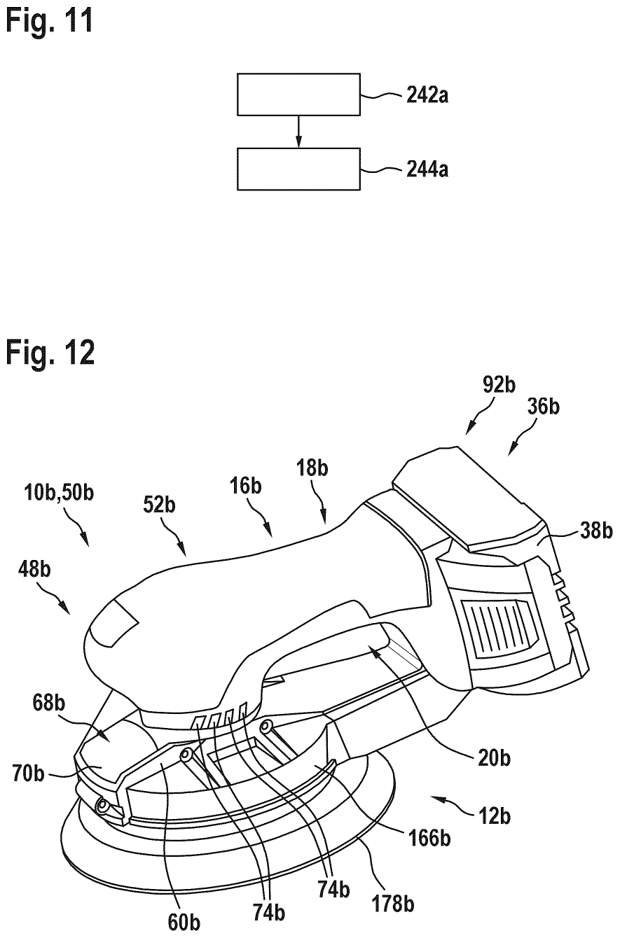

FIG. 11 a schematic sequence of a method for manufacturing a handheld power tool device for the handheld power tool, and

FIG. 12 a handheld power tool system with a handheld power tool in an alternative embodiment.

### DESCRIPTION OF THE EXEMPLARY EMBODIMENTS

FIG. 1 shows a handheld power tool system 36a comprising a handheld power tool 50a, in particular a handheld sander. The handheld power tool 50a is designed as a sander 10a, in particular as a battery-operated sander. Alternatively, however, it is also conceivable that the handheld power tool 50a, in particular the sander 10a, is designed as a grid-powered handheld power tool. The sander 10a is designed as a random orbital sander. Alternatively, however, it is also conceivable that the sander 10a is designed as an orbital sander, a delta sander, a flower sander, or the like.

The handheld power tool 50a comprises a tool holder 12a for holding a tool 178a. The tool holder 12a is designed as a sanding pad. The tool holder 12a is designed as a round sanding pad. Alternatively, however, it is also conceivable that the tool holder 12a is designed as a delta pad, as a square, preferably rectangular, sanding pad, or as another sanding pad that a skilled person considers useful.

The tool holder 12a comprises fastening means for fastening the tool 178a. The tool holder 12a preferably comprises a hook-and-loop surface 180a for fastening the tool 178a. Alternatively or additionally, it is conceivable that the fastening means comprise multiple hook-and-loop surfaces, one or multiple clips, a combination of these, or other fastening means that a skilled person considers useful. The tool 178a is designed as a sanding means, e.g. as an abrasive paper, an abrasive fleece, an abrasive grid, or the like.

The handheld power tool 50a comprises a drive unit 14a for driving the tool holder 12a. The drive unit 14a comprises a drive element 182a, preferably an eccentric (see FIG. 5). The drive element 182a is intended for driving about a drive axis 30a of the drive unit 14a. The handheld power tool 50a comprises an output unit 66a. The tool holder 12a is a portion of the output unit 66a. The output unit 66a comprises a connecting piece 90a. The connecting piece 90a is arranged, preferably fixed, on the drive element 182a. The tool holder 12a is fastened to the connecting piece 90a, in particular in a rotationally fixed manner, e.g. by means of a screw 184a or the like.

The output unit 66a comprises an output axis 186a. The output axis 186a preferably extends at least substantially parallel to the drive axis 30a. The drive axis 30a is at a distance from the output axis 186a. The connecting piece 90a and/or the tool holder 12a, in particular the output axis 186a, moves in at least one operating state about the drive axis 30a, preferably circularly. The drive element 182a is intended to drive the connecting piece 90a and/or the tool holder 12a, in particular the output axis 186a, to a, preferably circular, movement about the drive axis 30a of the drive element 182a.

The connecting piece 90a is rotatably attached to the drive element 182a, in particular rotatable about the output axis 186a. The handheld power tool 50a comprises at least one bearing element 188a. The connecting piece 90a is rotatably mounted on the drive element 182a via the bearing element 188a, in particular about the output axis 186a. The bearing element 188a is preferably arranged between the drive element 182a and the connecting piece 90a. The bearing element 188a can be designed as a radial bearing, in particular as a rolling bearing, e.g. as a ball bearing, or as a plain bearing.

The drive unit 14a is intended to drive the output unit 66a, in particular the tool holder 12a. The drive unit 14a comprises an electric motor 190a, in particular for driving the drive element 182a.

The handheld power tool 50a, in particular the sander 10a, comprises at least one further bearing element 300a. The drive element 182a is rotatably mounted on a drive housing 54a of the handheld power tool 50a via the further bearing element 300a, in particular rotatable about the drive axis 30a. The further bearing element 300a can be designed as a radial bearing, in particular as a rolling bearing, e.g. as a ball bearing, or as a plain bearing.

The handheld power tool 50, in particular the sander 10a, comprises a housing unit 16a. The housing unit 16a comprises a drive housing 54a for holding the drive unit 14a. The drive housing 54a is designed as a plastic housing. Alternatively, however, it is also conceivable that the drive housing 54a is at least partially designed as a metal housing, e.g. as an aluminum housing or the like.

The housing unit 16a comprises a handle housing 52a. The handle housing 52a is designed as a plastic housing. Alternatively, however, it is also conceivable that the handle housing 52a is at least partially designed as a metal housing, e.g. as an aluminum housing or the like. The handle housing 52a comprises two handle housing shells 192a, 194a, which are connected to one another in particular in a separating plane 146a of the handle housing 52a. The handle housing 52a is designed to be separate from the drive housing 54a, in particular arranged at a distance from the drive housing 54a. In particular, the handle housing 52a comprises a shell structure, with the two handle housing shells 192a, 194a acting as half shells.

The housing unit 16a comprises a bow-shaped handle 18a. The bow-shaped handle 18a is a portion of the handle housing 52a. The bow-shaped handle 18a comprises a finger grip surface 196a. The bow-shaped handle 18a comprises two walls 198a, in particular side walls, which delimit the finger grip surface 196a, in particular viewed in a main extension plane 42a of the bow-shaped handle 18a and in a direction perpendicular to the drive axis 30a. The bow-shaped handle 18a is designed as a closed bow-shaped handle. Alternatively, however, it is also conceivable that the bow-shaped handle 18a is designed as an open bow-shaped handle. The walls 198a define, in particular delimit, a handle recess 20a of the bow-shaped handle 18a at least partially.

A maximum longitudinal extent 22a of the handle recess 20a extends at least substantially parallel to a tool receiving surface 102a of the tool holder 12a. The maximum longitudinal extent 22a of the handle recess 20a extends in a main extension plane 64a of the handle housing 52a, preferably in the main extension plane 42a of the bow-shaped handle 18a, in particular in the separating plane 146a of the handle housing 52a. The tool holder surface 102a extends at least substantially perpendicular to the separating plane 146a, the main extension plane 64a of the handle housing 52a, and/or the main extension plane 42a of the bow-shaped handle 18a.

The main extension plane 42a of the bow-shaped handle 18a is in this case congruent with the main extension plane 64a of the handle housing 52a. Alternatively, it is conceivable that the main extension plane 42a of the bow-shaped handle 18a is different from the main extension plane 64a of the handle housing 52a. The separating plane 146a is in this case congruent with the main extension plane 64a of the handle housing 52a, in particular the main extension plane 42a of the bow-shaped handle 18a. Alternatively, however, it is also conceivable that the main extension plane 42a of the bow-shaped handle 18a and/or the main extension plane 64a of the handle housing 52a are/is different from the separating plane 146a.

A ratio of the maximum longitudinal extent 22a of the handle recess 20a of the bow-shaped handle 18a to a maximum longitudinal extent 24a of the tool holder 12a is at least 0.35, preferably at least 0.38. The ratio of the maximum longitudinal extent 22a of the handle recess 20a of the bow-shaped handle 18a to a maximum longitudinal extent 24a of the tool holder 12a is at most 0.5, preferably at most 0.45, and preferably at most 0.42. Particularly preferably, the ratio of the maximum longitudinal extent 22a of the handle recess 20a of the bow-shaped handle 18a to the maximum longitudinal extent 24a of the tool holder 12a is at least substantially 0.4.

The maximum longitudinal extent 22a of the handle recess 20a is at least 50 mm, preferably at least 55 mm, and particularly preferably at least 60 mm. The maximum longitudinal extent 22a of the handle recess 20a is at most 80 mm, preferably at most 70 mm, and particularly preferably at most 75 mm. The maximum longitudinal extent 22a of the handle recess 20a is in this case, by way of example, at least substantially 61 mm. Alternatively, however, it is also conceivable that the maximum longitudinal extent 22a of the handle recess 20a is greater than 80 mm or less than 50 mm.

The maximum longitudinal extent 24a of the tool holder 12a in this case corresponds in particular to a maximum diameter of the tool holder surface 102a. The maximum longitudinal extent 24a is in this case, by way of example, 150 mm, in particular between 148 mm and 152 mm. Alternatively, however, it is also conceivable that the maximum longitudinal extent 24a of the tool holder 12a, in particular the maximum diameter of the tool holder surface 102a, is greater than 150 mm, in particular greater than 152 mm, or smaller than 150 mm, in particular smaller than 148 mm.

A maximum diameter of the tool 178a is greater than the maximum longitudinal extent 24a of the tool holder 12a. Alternatively, however, it is also conceivable that the maximum diameter of the tool 178a is the same size or smaller than the maximum longitudinal extent 24a of the tool holder 12a.

The maximum longitudinal extent 24a of the tool holder 12a extends at least substantially parallel to the maximum longitudinal extent 22a of the handle recess 20a and/or the tool holder surface 102a. The maximum longitudinal extent 24a of the tool holder 12a extends along the separating plane 146a of the handle housing 52a, the main extension plane 64a of the handle housing 52a, and/or in the main extension plane 42a of the bow-shaped handle 18a. The maximum longitudinal extent 24a of the tool holder 12a is defined by a maximum longitudinal extent of the tool holder surface 102a. The tool 178a is intended to be arranged on the tool holder surface 102a. The hook and loop surface 180a corresponds to the tool holder surface 102a.

The handle housing 52a comprises a palm grip 160a, in particular a grip knob. The palm grip 160a is arranged such that the drive axis 30a intersects the palm grip 160a. In particular, the bow-shaped handle 18a merges into the palm grip 160a, preferably adjoining the palm grip 160a.

The handheld power tool 50a comprises an extraction fan 168a. The extraction fan 168a is intended for suction away from the workpiece during the machining of a workpiece and, in particular to blow it out of a dust outlet 44a.

A fan housing 166a of the housing unit 16a, in particular of the drive housing 54a, for holding the extraction fan 168a is arranged between the tool holder 12a and the palm grip 160a. The handle housing 52a, in particular the palm grip 160a, surround a motor housing 78a of the drive housing 54a, preferably at least in a plane extending perpendicular to the drive axis 30a.

The sander 10a comprises a battery pack interface 218a for electrical and/or mechanical connection to a battery pack 38a. The battery pack interface 218a includes guidance means, e.g. one or multiple guide rails or the like, for guiding the battery pack 38a during an assembly and/or disassembly of the battery pack 38a to and/or from the battery pack interface 218a. The battery pack interface 218a, in particular the guidance means, specifies an insertion direction for the battery pack 38a when the battery pack 38a is mounted on the battery pack interface 218a. The direction of insertion preferably extends at least substantially perpendicular to the drive axis 30a, to the separating plane 146a, to the main extension plane 42a of the bow-shaped handle 18a, and/or to the main extension plane 64a of the handle housing 52a. The insertion direction extends at least substantially parallel to the tool holder surface 102a.

The battery pack interface 218a is arranged on the handle housing 52a, in particular on a side of the bow-shaped handle 18a facing away from the palm grip 160a. The battery pack interface 218a has no interface with the drive axis 30a and/or with a main extension plane 232a of the tool holder surface 102a.

The handheld power tool 50a comprises at least one input element 162a. The handheld power tool 50a can be switched on and/or off by an actuation of the input element 162a by the operator. Alternatively or additionally, it is conceivable that a rotational speed of the handheld power tool 50a or the like can be adjustable by way of the input element 162a. The input element 162a can, e.g. be designed as a button, a rotary wheel, a switch, or the like. The input element 162a is arranged on the palm grip 160a, preferably on a side of the palm grip 160a facing away from the battery pack interface 218a, the tool holder 12a and/or the bow-shaped handle 18a.

The sander 10a is intended to be guided with one hand, in particular by means of the bow-shaped handle 18a and the palm grip 160a. Alternatively, however, it is also conceivable that the sander 10a is designed as a two-hand guide, whereby one hand of the operator is arranged on the palm grip 160a and one on the bow-shaped handle 18a.

A center of gravity 26a of the handheld power tool 50a is arranged in the handle recess 20a. The center of gravity 26a is arranged within the handle recess 20a, viewed at least in a direction perpendicular to the main extension plane 42a of the bow-shaped handle 18a, in particular to the main extension plane 64a of the handle housing 52a.

A minimum distance (not shown in this case) of the center of gravity 26a from the separating plane 146a of the handle housing 52a, from the main extension plane 64a of the handle housing 52a, and/or from the main extension plane 42a of the bow-shaped handle 18a is smaller than a maximum transverse extent 200a of the handle housing 52a, starting from the separating plane 146a of the handle housing 52a, the main extension plane 64a of the handle housing 52a, and/or the main extension plane 42a of the bow-shaped handle 18a. It is also conceivable that the center of gravity 26a is arranged in the separating plane 146a of the handle housing 52a, in the main extension plane 64a of the handle housing 52a, and/or in the main extension plane 42a of the bow-shaped handle 18a.

The maximum transverse extent 200a of the handle housing 52a, in particular of the bow-shaped handle 18a, in particular starting from the separating plane 146a of the handle housing 52a, the main extension plane 64a of the handle housing 52a, and/or the main extension plane 42a of the bow-shaped handle 18a, extends at least substantially perpendicular to the main extension plane 42a of the bow-shaped handle 18a, in particular to the main extension plane 64a of the handle housing 52a, to the separating plane 146a, and/or to the drive axis 30a. The maximum transverse extent 200a of the handle housing 52a, in particular of the bow-shaped handle 18a, in particular starting from the separating plane 146a of the handle housing 52a, the main extension plane 64a of the handle housing 52a, and/or the main extension plane 42a of the bow-shaped handle 18a, extends at least substantially parallel to the tool holder surface 102a.

A ratio of a maximum distance 28a of the tool holder 12a from the center of gravity 26a in the direction of the drive axis 30a of the drive unit 14a to a minimum distance 32a between the drive axis 30a and the center of gravity 26a is at least 2.8, preferably at least 3.0, preferably at least 3.1. The ratio of a maximum distance 28a of the tool holder 12a from the center of gravity 26a in the direction of the drive axis 30a of the drive unit 14a to a minimum distance 32a between the drive axis 30a and the center of gravity 26a is at most 3.5, preferably at most 3.2.

The maximum distance 28a of the tool holder 12a from the center of gravity 26a in the direction of the drive axis 30a is at least 30 mm, preferably at least 33 mm, preferably at least 35 mm. The maximum distance 28a of the tool holder 12a from the center of gravity 26a in the direction of the drive axis 30a is in particular at most 50 mm, preferably at most 45 mm and particularly preferably at most 40 mm. By way of example, the maximum distance 28a of the tool holder 12a from the center of gravity 26a in the direction of the drive axis 30a is at least substantially 38 mm here. Alternatively, however, it is also conceivable that the maximum distance 28a of the tool holder 12a from the center of gravity 26a in the direction of the drive axis 30a is less than 30 mm or greater than 50 mm.

The minimum distance 32a of the drive axis 30a from the center of gravity 26a is in particular at least 8 mm, preferably at least 10 mm. The minimum distance 32a of the drive axis 30a from the center of gravity 26a is in particular at most 20 mm, preferably at most 15 mm. By way of example, the minimum distance 32a of the drive axis 30a from the center of gravity 26a is at least substantially 38 mm. Alternatively, however, it is also conceivable that the minimum distance 32a of the drive axis 30a from the center of gravity 26a is less than 8 mm or greater than 20 mm.

The maximum distance 28a of the tool holder 12a from the center of gravity 26a in the direction of the drive axis 30a is defined by a distance of the tool holder surface 102a from the center of gravity 26a in the direction of the drive axis 30a.

The drive axis 30a extends at least substantially perpendicular to the tool holder surface 102a. The drive axis 30a extends at least substantially parallel to the main extension plane 64a of the handle housing 52a, in particular to the main extension plane 42a of the bow-shaped handle 18a, and/or to the separating plane 146a. The drive axis 30a extends along the main extension plane 64a of the handle housing 52a, along the main extension plane 42a of the bow-shaped handle 18a, and/or along the separating plane 146a.

The minimum distance 32a between the drive axis 30a and the center of gravity 26a is at least substantially perpendicular to the drive axis 30a. The minimum distance 32a between the drive axis 30a and the center of gravity 26a extends at least substantially parallel to the tool holder surface 102a, to the main extension plane 64a of the handle housing 52a, to the main extension plane 42a of the bow-shaped handle 18a, and/or to the separating plane 146a.

A maximum height 34a of the handheld power tool 50a, in particular of the sander 10a, has a ratio of at least 2.8, preferably at least 3.0, in the direction of the drive axis 30a to the maximum distance 28a between the tool holder 12a and the center of gravity 26a in the direction of the drive axis 30a. The ratio of the maximum height 34a of the sander 10a in the direction of the drive axis 30a to the maximum distance 28a between the tool holder 12a and the center of gravity 26a in the direction of the drive axis 30a is at most 3.2, preferably at most 3.1.

The maximum height 34a of the sander 10a is in this case, by way of example, at least 100 mm, preferably at least 110 mm. The maximum height 34a of the sander 10a is in this case, by way of example, at most 130 mm, preferably at most 120 mm. Alternatively, however, it is also conceivable that the maximum height 34a of the sander 10a in the direction of the drive axis 30a is less than 110 mm or greater than 130 mm. The maximum height 34a of the sander 10a in the direction of the drive axis 30a extends from the tool holder surface 102a parallel to the drive axis 30a to an outermost point of the handle housing 52a.

A ratio of the maximum height 34a of the sander 10a to a maximum height 202a of the handle recess 20a in a direction extending parallel to the drive axis 30a is at least 4.0, preferably at least 4.3, particularly preferably at least 4.4. The ratio of the maximum height 34a of the sander 10a to the maximum height 202a of the handle recess 20a extending in a direction parallel to the drive axis 30a is at most 5.0, preferably at most 4.7, particularly preferably at most 4.6. The maximum height 34a of the handle recess 20a is in this case, by way of example, between 20 mm and 30 mm, preferably between 24 mm and 28 mm, and particularly preferably at least substantially 26 mm.

The handle recess 20a is closed, preferably substantially ovally closed. The handle recess 20a is closed when viewed in the main extension plane 42a of the bow-shaped handle 18a, in the main extension plane 64a of the handle housing 52a, and/or in the separating plane 146a. The handle recess 20a is closed by walls of the drive housing 54a, in particular the fan housing 166a of the drive housing 54a, and the handle housing 52a. Alternatively, it is conceivable that the handle recess 20a is completely closed by walls of the handle housing 52a.

The handle recess 20a has an oval shape, in particular when viewed in a direction perpendicular to the main extension plane 42a of the bow-shaped handle 18a, preferably to the main extension plane 64a of the handle housing 52a. Alternatively, however, it is also conceivable that the handle recess 20a has a rectangular shape, a square shape, a circular shape, or another shape that a skilled person considers useful, in particular when viewed in the direction perpendicular to the main extension plane 42a of the bow-shaped handle 18a, preferably to the main extension plane 64a of the handle housing 52a.

The handheld power tool system 36a comprises the battery pack 38a for supplying power to the handheld power tool 50a. The battery pack 38a has a battery pack center of gravity 40a. In a state arranged on the sander 10a, the battery pack center of gravity 40a is offset from the main extension plane 42a of the bow-shaped handle 18a.

A minimum distance (not shown in this case) of the battery pack center of gravity 40a from the separating plane 146a of the handle housing 52a, from the main extension plane 64a of the handle housing 52a and/or from the main extension plane 42a of the bow-shaped handle 18a is smaller than the maximum transverse extent 200a of the handle housing 52a, in particular of the bow-shaped handle 18a, starting from the separating plane 146a of the handle housing 52a, the main extension plane 64a of the handle housing 52a, or the main extension plane 42a of the bow-shaped handle 18a.

The minimum distance of the battery pack center of gravity 40a from the separating plane 146a of the handle housing 52a, from the main extension plane 64a of the handle housing 52a, and/or from the main extension plane 42a of the bow-shaped handle 18a is in particular less than 20 mm, preferably less than 15 mm, and preferably less than 10 mm. The minimum distance of the battery pack center of gravity 40a from the separating plane 146a of the handle housing 52a, from the main extension plane 64a of the handle housing 52a, and/or from the main extension plane 42a of the bow-shaped handle 18a is in this case, by way of example, at least substantially 8 mm.

The handheld power tool system 36a comprises a dust outlet 44a. The dust outlet 44a is arranged on the drive housing 54a, in particular on the fan housing 166a. The battery pack center of gravity 40a and the dust outlet 44a are arranged on different sides of the main extension plane 42a of the bow-shaped handle 18a. The center of gravity 26a of the sander 10a and the battery pack center of gravity 40a are arranged on different sides of the main extension plane 42a of the bow-shaped handle 18a.

The handheld power tool system 36a comprises a dust collection container 262a, e.g. a dust box, a dust bag, or the like (see FIG. 2). The dust collection container 262a can be attached, in particular detachably, to the dust outlet 44a, e.g. by means of a screw connection, a latching connection, or the like. Alternatively, it is also conceivable that at least one dust outlet connecting piece of the dust collection container 262a is designed to be integral with the dust outlet 44a.

The dust collection container 262a is rotatably mounted on the dust outlet 44a. Alternatively, however, it is also conceivable that the dust collection container 262a can be connected to the dust outlet 44a in a rotationally fixed manner. The dust collection container 262a is intended for collecting dust and/or material removed by extraction, preferably by means of the suction fan 168a.

Alternatively or additionally, it is conceivable that the dust outlet 44a can be coupled to an active extraction device (not shown in this case), e.g. a vacuum cleaner or the like, in particular in the case of a handheld power tool 50a which is designed without an extraction fan 168a. The dust outlet 44a is arranged on one side of the separating plane 146a, the main extension plane 42a of the bow-shaped handle 18a, and/or the main extension plane 64a of the handle housing 52a.

A ratio of a minimum distance 46a between the battery pack center of gravity 40a in a state arranged on the sander 10a and the drive axis 30a to the maximum longitudinal extent 24a of the tool holder 12a is at least 0.85 and at most 1.2.

The minimum distance 46a between the battery pack center of gravity 40a in a state arranged on the sander 10a and the drive axis 30a extends at least substantially parallel to the tool holder surface 102a, the main extension plane 42a of the bow-shaped handle 18a, the main extension plane 64a of the handle housing 52a, and/or the separating plane 146a. The minimum distance 46a between the battery pack center of gravity 40a in a state arranged on the sander 10a and the drive axis 30a extends at least substantially perpendicular to the drive axis 30a.

By way of example, the minimum distance 46a between the battery pack center of gravity 40a and the drive axis 30a is at least substantially 136 mm for a battery pack 38a with 4 Ah electrical charge capacity, at least substantially 148 mm for a battery pack 38a with 8 Ah electrical charge capacity and at least substantially 160 mm for a battery pack 38a with 12 Ah electrical charge capacity.

The ratio of the minimum distance 46a between the battery pack center of gravity 40a in a state arranged on the sander 10a and the drive axis 30a to the maximum longitudinal extent 24a of the tool holder 24a is at least 0.85 and at most 0.95, preferably at least substantially 0.9, for a battery pack 38a with 4 Ah electrical charge capacity.

The ratio of the minimum distance 46a between the battery pack center of gravity 40a in a state arranged on the sander 10a and the drive axis 30a to the maximum longitudinal extent 24a of the tool holder 24a is at least 0.95 and at most 1.05, preferably at least substantially 1.0, for a battery pack 38a with 8 Ah electrical charge capacity.

The ratio of the minimum distance 46a between the battery pack center of gravity 40a in a state arranged on the sander 10a and the drive axis 30a to the maximum longitudinal extent 24a of the tool holder 24a is at least 1.0 and at most 1.1, preferably at least substantially 1.07, for a battery pack 38a with 12 Ah electrical charge capacity.

An overall center of gravity 176a of the handheld power tool system 36a is arranged in the handle recess 20a of the bow-shaped handle 18a. The overall center of gravity 176a of the handheld power tool system 36a pertains to the handheld power tool 50a with the battery pack 38a and has no dust collection container 262a and/or guard 120a. A minimum distance (not shown in this case) of the overall center of gravity 176a from the separating plane 146a of the handle housing 52a, from the main extension plane 64a of the handle housing 52a and/or from the main extension plane 42a of the bow-shaped handle 18a is smaller than the maximum transverse extent 200a of the handle housing 52a, in particular of the bow-shaped handle 18a, starting from the separating plane 146a of the handle housing 52a, the main extension plane 64a of the handle housing 52a, and/or the main extension plane 42a of the bow-shaped handle 18a. It is conceivable that the overall center of gravity 176a is arranged in the separating plane 146a of the handle housing 52a, in the main extension plane 64a of the handle housing 52a, and/or in the main extension plane 42a of the bow-shaped handle 18a.

A minimum distance 302a of the drive axis 30a from the overall center of gravity 176a has a value of at least 55 mm to at least 70 mm, in particular depending on a weight of the battery pack 38a. The minimum distance 302a of the drive axis 30a from the overall center of gravity 176a has a value of at most 65 mm to at most 75 mm, in particular depending on the weight of the battery pack 38a.

A maximum distance 304a of the tool holder 12a from the overall center of gravity 176a in the direction of the drive axis 30a has a value of at least 45 mm to at least 50 mm, in particular depending on the weight of the battery pack 38a. The maximum distance 304a of the tool holder 12a from the overall center of gravity 176a in the direction of the drive axis 30a has a value of at most 52 mm to at most 55 mm, in particular depending on a weight of the battery pack 38a.

Preferably, the overall center of gravity 176a of the handheld power tool system 36a is arranged with at least one battery pack 38a with a single-layer battery cell arrangement within the handle recess 20a of the bow-shaped handle 18a. A position of the overall center of gravity 176a of the handheld power tool system 36a with a battery pack 38a with a single-layer battery cell arrangement is such that the handheld power tool 50a can be placed on the tool holder 12a, in particular without tilting.

By way of example, the minimum distance 302a of the drive axis 30a from the overall center of gravity 176a is at least substantially 60 mm for a battery pack 38a with 4 Ah of electrical charging capacity and at least substantially 72 mm for a battery pack 38a with 8 Ah of electrical charging capacity.

By way of example, the maximum distance 304a from the tool holder 12a to the overall center of gravity 176a in the direction of the drive axis 30a is at least substantially 50 mm for a battery pack 38a with 4 Ah electrical charging capacity and at least substantially 53 mm for a battery pack 38a with 8 Ah electrical charging capacity.

A ratio of the minimum distance 46a between the battery pack center of gravity 40a in a state arranged on the sander 10a and the drive axis 30a to the maximum longitudinal extent 22a of the handle recess 20a of the bow-shaped handle 18a is at least 2.0 and at most 3.0.

The ratio of the minimum distance 46a between the battery pack center of gravity 40a in a state arranged on the sander 10a and the drive axis 30a to the maximum longitudinal extent 22a of the handle recess 20a of the bow-shaped handle 18a is at least 2.0 and at most 2.5, preferably at least substantially 2.2, for a battery pack 38a with 4 Ah electrical charging capacity.

The ratio of the minimum distance 46a between the battery pack center of gravity 40a in a state arranged on the sander 10a and the drive axis 30a to the maximum longitudinal extent 22a of the handle recess 20a of the bow-shaped handle 18a is at least 2.2 and at most 2.6, preferably at least substantially 2.4, for a battery pack 38a with 8 Ah electrical charging capacity.

The ratio of the minimum distance 46a between the battery pack center of gravity 40a in a state arranged on the sander 10a and the drive axis 30a to the maximum longitudinal extent 22a of the handle recess 20a of the bow-shaped handle 18a is at least 2.4 and at most 2.8, preferably at least substantially 2.6, for a battery pack 38a with 12 Ah electrical charging capacity.

The handheld power tool 50a comprises a handheld power tool device 48a, in particular a handheld sander device. The handheld power tool device 48a comprises the housing unit 16a.

The drive housing 54a defines the drive axis 30a of the drive unit 14a. In particular, the motor housing 78a defines the drive axis 30a. The motor housing 78a comprises a motor holder, in the central longitudinal axis of which a motor axis 260a comes to rest. The drive axis 30a is defined by the motor axis 260a. In particular, the central longitudinal axis is congruent with the drive axis 30a. The drive housing 54a is coupled to the handle housing 52a.

The drive housing 54a comprises a center bar 60a on a surface 56a of an upper side 58a of the drive housing 54a, which is raised relative to the surface 56a. An end 62a of the handle housing 52a is arranged above the center bar 60a. The center bar 60a drops onto the surface 56a in both directions, starting from a main extension plane 64a of the handle housing 52a and extending perpendicularly to the main extension plane 64a of the handle housing 52a.

Two screw domes 280a of the drive housing 54a are arranged on side walls 278a of the center bar 60a. In particular, the center bar 60a protrudes in a radial direction with respect to the drive axis 30a, whereby a further screw dome 282a of the drive housing 54a is arranged in the protruding region of the center bar 60a.

A maximum transverse extent 306a of the center bar 60a is smaller than a maximum total transverse extent 204a of the handle housing 52a. The maximum transverse extent 306a of the center bar 60a is at least substantially perpendicular to the main extension plane 42a of the bow-shaped handle 18a, to the main extension plane 64a of the handle housing 52a, to the separating plane 146a, and/or to the drive axis 30a. The maximum transverse extent 306a of the center bar 60a extends at least substantially parallel to the tool holder surface 102a of the tool holder 12a. The maximum transverse extent 306a of the center bar 60a is smaller than a maximum transverse extent 206a of the handle housing 52a at the end 62a of the center bar 60a arranged above the center bar 60a (see FIG. 3). The end 62a of the handle housing 52a is arranged above the center bar 60a with respect to the tool holder 12a and/or the surface 56a.

The center bar 60a has a main extension axis 208a. The main extension axis 208a of the center bar 60a extends at least substantially perpendicular to the drive axis 30a. The main extension axis 208a of the center bar 60a extends at least substantially parallel to the main extension plane 42a of the bow-shaped handle 18a, to the main extension plane 64a of the handle housing 52a, to the separating plane 146a, and/or to the tool holder surface 102a. The main extension axis 208a of the center bar 60a extends in the main extension plane 42a of the bow-shaped handle 18a, in the main extension plane 64a of the handle housing 52a and/or in the separating plane 146a.

The center bar 60a extends, in particular at least in the direction of the main extension axis 208a of the center bar 60a, over a large portion of the surface 56a, preferably over at least 50%, preferably over at least 75%, and particularly preferably over 90% of the surface 56a. The upper side 58a, preferably the surface 56a, is arranged facing away from the tool holder 12a. The center bar 60a has a curvature in the longitudinal direction, in particular in the direction of the main extension axis 208a of the center bar 60a, preferably a curvature adapted to the surface 56a. Alternatively, however, it is also conceivable that the center bar 60a is designed with no curvature in the longitudinal direction.

The handle housing 52a covers the center bar 60a at least partially on both sides along an axis extending perpendicular to the main extension plane 64a of the handle housing 52a. The handle housing 52a covers the center bar 60a in the directions perpendicular to the main extension plane 64a of the handle housing 52a on both sides at a height of at least 10%. It is also conceivable that the handle housing 52a largely covers the center bar 60a on both sides at a height in the directions extending perpendicular to the main extension plane 64a of the handle housing 52a, in particular at least 50%, preferably at least 70%, and preferably at least 90%. The center bar 60a is not covered by the handle housing 52a in the longitudinal direction.

An end 62a of the handle housing 52a facing the center bar 60a, in particular the end specified hereinabove, preferably an end 62a substantially surrounding the drive housing 54a in a ring-like manner, is arranged at a distance from the drive housing 54a, in particular at a radial and axial distance. The end 62a is arranged at a distance from the surface 56a.

The motor housing 78a is arranged on the center bar 60a. The end 62a surrounds the motor housing 78a like a ring. The motor housing 78a is arranged on a side of the center bar 60a facing away from the tool holder 12a, in particular arranged above the center bar 60a with respect to the tool holder 12a. The motor housing 78a is enclosed by the handle housing 52a in a plane perpendicular to the drive axis 30a. The motor housing 78a is at least substantially completely enclosed by the handle housing 52a in the radial direction starting from the drive axis 30a. The motor housing 78a is designed to be at least partially integral with the center bar 60a. The handle housing 52a, in particular the end 62a of the handle housing 52a, is arranged at a distance from the drive housing 54a, in particular from the motor housing 78a.

The end 62a of the handle housing 52a facing the center bar 60a is adapted in shape to the drive housing 54a, in particular the center bar 60a and/or the surface 56a. The end 62a comprises two recesses 210a for the center bar 60a. It is conceivable that the end 62a is at a constant distance from the drive housing 54a in the direction of the drive axis 30a. Alternatively, however, it is also conceivable that the distance between the end 62a and the drive housing 54a varies in the direction of the drive axis 30a.

The center bar 60a comprises a holder 68a for an operator interface 70a. Alternatively or additionally, it is conceivable that the center bar 60a comprises the holder 68a for a communication module 72a. The operator interface 70a and/or the communication module 72a are/is a portion of the handheld power tool 50a, in particular the sander 10a, preferably the handheld power tool device 48a.

The communication module 72a can comprise one or multiple data transmission technologies, e.g. Bluetooth, NFC, or the like. Alternatively, it is conceivable that the handheld power tool 50a, in particular the handheld power tool device 48a, is designed without a communication module 72a.

The holder 68a is designed as a recess in the center bar 60a. The holder 68a is arranged on a side of the motor housing 78a facing away from the bow-shaped handle 18a. The holder 68a is arranged on a side of the handle housing 52a facing away from the battery pack interface 218a of the handheld power tool 50a. The battery pack interface 218a is arranged on a side of the handheld power tool 50a, in particular the sander 10a, facing away from the operator interface 70a.

In this case, the operator interface 70a in this case comprises, by way of example, two input elements 212a. Alternatively, however, it is also conceivable that the operator interface 70a comprises only one input element 212a or more than two input elements 212a. The input elements 212a of the operator interface 70a are in this case, by way of example, designed as buttons. Alternatively, it is conceivable that at least one of the input elements 212a is designed as a rotary wheel, a switch, or the like. By way of example, the handheld power tool 50a can be switched on and/or off via the operator interface 70a, in particular the input elements 212a, a rotational speed of the handheld power tool 50a, preferably of the sander 10a, can be adjusted or the like.

The operator interface 70a in this case comprises, by way of example, five output elements 214a. Alternatively, it is conceivable that the operator interface 70a comprises fewer or more than four output elements 214a. The output elements 214a are designed as lighting elements, in particular LEDs. Alternatively, it is conceivable that at least one of the output elements 214a is designed as a display or the like. By way of example, the operator interface 70a, in particular via at least one of the output elements 214a, can be used to output a rotational speed of the handheld power tool 50a, preferably of the sander 10a, a charge status of the battery pack 38a, a device status of the handheld power tool 50a, or the like.

The operator interface 70a is connected by data technology to a control unit 216a of the handheld power tool 50a, in particular the sander 10a, preferably in a wired and/or wireless manner. The control unit 216a is intended to control the drive unit 14a. In particular, the control unit 216a comprises at least one processor and one memory element, as well as an operating program stored on the memory element. The memory element is designed as a digital storage medium, e.g. as a hard disk or the like. The control unit 216a is arranged in the handle housing 52a.

The communication module 72a is configured to communicate with another device, e.g. a smartphone, a laptop, a server, a cloud, a gateway, or the like. The communication module 72a is connected to the control unit 216a and/or the operator interface 70a by data, in particular in a wireless and/or by wired manner.

The communication module 72a is designed and in particular arranged to be separate from the operator interface 70a. The communication module 72a is in this case, by way of example, arranged in the handle housing 52a, in particular in the bow-shaped handle 18a. The communication module 72a is arranged between the motor housing 78a and the battery pack interface 218a. The communication module 72a is arranged on a side of the handle housing 52a on which the battery pack interface 218a is arranged. It is also conceivable that the communication module 72a is a portion of the control unit 216a. Alternatively, it is conceivable that the communication module 72a is arranged in a support 220a of the handle housing 52a on the drive housing 54a, or in another position that a skilled person considers useful. Alternatively, it is also conceivable that the communication module 72a is a portion of the operator interface 70a.

The handheld power tool 50a comprises multiple cooling air inlet openings 266a. Alternatively, it is conceivable that the handheld power tool 50a only comprises a cooling air inlet opening 266a. The cooling air inlet openings 266a are in this case, by way of example, arranged on the handle housing 52a, in particular on the bow-shaped handle 18a. The cooling air inlet openings 266a are arranged on a wall of the handle housing 52a delimiting the handle recess 20a. The cooling air inlet openings 266a are arranged on a wall of the handle housing 52a facing the tool holder 12a and delimiting the handle recess 20a. Alternatively, it is also conceivable that the cooling air inlet openings 266a are arranged on a wall that is closest to the battery pack interface 218a and delimits the handle recess 20a. Alternatively, however, it is also conceivable that the cooling air inlet openings 266a are arranged on the drive housing 54a or at another position on the handle housing 52a that a skilled person considers useful.

The handheld power tool 50a comprises a motorized fan 268a. The motor fan 268a is arranged in the drive housing 54a, in particular in the motor housing 78a. The motor fan 268a is intended for cooling the drive unit 14a, in particular the electric motor 190a. It is also conceivable that the control unit 216a can be cooled by means of the motor fan 268a. In particular, the engine fan 268a is intended to draw in ambient air via the cooling air inlet openings 266a. The motorized fan 268a can be driven by the drive unit 14a.

The drive housing 54a comprises multiple air outlet openings 74a, which are at least partially covered by the handle housing 52a, in particular when viewed at least in a respective main outlet direction 76a of the air outlet openings 74. Alternatively, however, it is conceivable that the drive housing 54a only comprises one air outlet opening 74, which is at least partially covered by the handle housing 52a, in particular when viewed at least in a main outlet direction 76a of the air outlet opening 74a. The engine fan 268a is intended to direct the air drawn in via the cooling air inlet openings 266a via the drive unit 14a to the air outlet openings 74a and, in particular, to blow the engine exhaust air out of the air outlet openings 74a.

The handle housing 52a has no air outlet openings. The drive housing 54a, in particular the motor housing 78a, comprises cooling air inlet openings 270a. The cooling air inlet openings 270a of the engine housing 78a are arranged on a side of the engine housing 78a facing away from the tool holder 12a. The cooling air inlet openings 270a of the motor housing 78a are arranged within the handle housing 52a, in particular within the palm grip 160a. The cooling air drawn in via the cooling air inlet openings 270a of the motor housing 78a can be introduced into the motor housing 78a via the cooling air inlet openings 270a on the handle housing 52a.

The air outlet openings 74a are at least partially covered by the handle housing 52a, at least when viewed in a plane extending perpendicular to the drive axis 30a. It is conceivable that the handle housing 52a covers at least most of the air outlet openings 74a, preferably at least 50%, preferably at least 75%, and particularly preferably at least 90%, in particular when viewed in a plane perpendicular to the drive axis 30a. It is also conceivable that the handle housing 52a completely covers the air outlet openings 74a, in particular when viewed in a plane perpendicular to the drive axis 30a. The air outlet openings 74a are covered by the end 62a of the handle housing 52a, in particular when viewed in a plane extending perpendicular to the drive axis 30a.

The motor housing 78a comprises the air outlet openings 74a. The air outlet openings 74a are arranged above the center bar 60a with respect to the tool holder 12a and/or the surface 56a. The air outlet openings 74a are in this case arranged, by way of example, at a distance from one another in a circumferential direction, which in particular extends in a plane perpendicular to the drive axis 30a.

The main outlet directions 76a (in FIG. 4, only the main outlet direction 76a of one of the air outlet openings 74a is shown by way of example) are determined by an arrangement and/or geometry of the respective air outlet opening 74a. The main outlet directions 76a extend in this case, by way of example, at least substantially perpendicular to the drive axis 30a. Alternatively, however, it is also conceivable that the main outlet directions 76a extend at an angle to the drive axis 30a, preferably inclined in the direction of the tool holder 12a.

An opening 80a for the escape of air from the air outlet openings 74a is formed between the end 62a of the handle housing 52a facing the center bar 60a and the drive housing 54a. The opening 80a is arranged opposite the upper side 58a. The opening 80a is formed by arranging the end 62a of the handle housing 52a at a distance from the driving housing 54a, preferably the motor housing 78a.

The drive housing 54a comprises a closed cable channel 82a. At least a part, in particular a large part, preferably at least 50%, preferably at least 70%, of the cable channel 82a is covered by the handle housing 52a, in particular when viewed in a plane extending perpendicular to the drive axis 30a.

An open end 222a of the cable channel 82a is arranged at the holder 68a. A further open end 224a of the cable channel 82a is arranged in an inner region 226a of the handle housing 52a. The cable channel 82a extends from the holder 68a into the inner region 226a of the handle housing 52a. The cable channel 82a extends, in particular in the direction of the drive axis 30a, over the entire motor housing 78a.

The handheld power tool 50a and/or the handheld power tool device 48a comprises an electrical connection unit (not shown in this case). The electrical connection unit comprises at least one electrical connection element, e.g. a cable. The electrical connection unit, in particular the electrical connection element, is intended to connect the operator interface 70a to the control unit 216a, in particular at least in terms of data technology and/or control technology. The operator interface 70a can be supplied with electrical energy via the electrical connection unit, preferably via the at least one electrical connection element and/or a further electrical connection element of the electrical connection unit.

The cable channel 82a is intended to hold at least a portion of the electrical connection unit, in particular at least the electrical connection element and/or the further electrical connection element. The electrical connection unit, in particular the at least one electrical connection element and/or the further electrical connection element, are/is arranged at least partially in the cable channel 82a. The holder 68a comprises at least one electrical connection (not shown in this case) for the operator interface 70a. At least the electrical connection element and/or the further electrical connection element is/are connected to the connection.

The drive housing 54a comprises at least two housing shells 84a, 86a. The drive housing 54a has a shell structure, with the two housing shells 84a, 86 acting as half shells. The two housing shells 84a, 86a of the drive housing 54a are connected to one another in a drive housing separating plane 228a of the drive housing 54a. The drive housing separating plane 228a extends at least substantially parallel to the separating plane 146a of the handle housing 52a. It is conceivable that the drive housing separating plane 228a corresponds to the separating plane 146a of the handle housing 52a. Alternatively, however, it is also conceivable that the drive housing separating plane 228a extends at an angle to separating plane 146a.

The cable channel 82a is arranged between the housing shells 84a, 86a. The cable channel 82a extends within the outer walls of the housing shells 84a, 86a, in particular within at least one outer wall of one of the housing shells 84a, 86a. The cable channel 82a adjoins a contact surface of the outer walls of the two housing shells 84a, 86a. A housing shell 84a of the housing shells 84a, 86a comprises a groove 88a for the cable channel 82a. A further housing shell 86a of the housing shells 84a, 86a forms a cover (not shown in this case) for the cable channel 82a.

The cable channel 82a is arranged at least partially on, in particular in, the center bar 60a. It is conceivable that at least a portion of the cable channel 82a extends through the center bar 60a, e.g. at least 5%, 10%, or 20% of the cable channel 82a.

The handheld power tool system 36a comprises a support unit 92a, which is designed for placing and/or storing the sander 10a on a work surface 94a in at least one placement and/or storage position, whereby the battery pack 38a comprises a support surface 96a of the support unit 92a for the at least one placement and/or storage position. FIG. 7 shows the handheld power tool system 36a in the placement and/or storage position.

The support surface 96a is in this case, by way of example, a continuous surface, which in particular rests on the work surface 94a in the at least one placement and/or storage position. The support surface 96a is in this case, by way of example, a flat surface. The work surface 94a can, e.g., be a floor, a table, or the like. In particular, the battery pack 38a comprises a battery pack housing 112a. The battery pack housing 112a comprises the support surface 96a.

The battery pack 38a comprises a handheld power tool interface 230a for an electrical connection with the handheld power tool 50a, in particular the sander 10a. The handheld power tool interface 230a is intended to be arranged at the battery pack interface 218a. The support surface 96a is arranged on a side of the battery pack 38a facing away from the handheld power tool interface 230a.

In a state of the tool 178a arranged on the tool holder 12a, the tool holder 12a and/or the tool 178a are/is at a distance from the work surface 94a in the placement and/or storage position. In the placement and/or storage position, the sander 10a can only be stored via the support surface 96a. In the placement and/or storage position, the sander 10a is at a distance from the work surface 94a. In the placement and/or storage position, the sander 10a is connected to the work surface 94a via the battery pack 38a and can preferably be placed on the work surface 94a. In the placement and/or storage position, only the support surface 96a on the battery pack 38a of the handheld power tool system 36a is in contact with the work surface 94a.

A main extension plane 98a of the support surface 96a extends to the main extension plane 232a of the tool holder surface 102a of the tool holder 12a at an angle 104a other than 90°. A main extension axis (not shown in this case) of the handheld power tool 50a, in particular of the sander 10a, extends at an angle other than 90° to the main extension plane 98a of the support surface 96a in the placement and/or storage position. The tool holder surface 102a extends at least substantially parallel to the main extension axis of the handheld power tool 50a, in particular of the sander 10a. Alternatively, it is conceivable that the tool holder surface 102a extends at an angle to the main extension axis of the handheld power tool 50a, in particular the sander 10a.

In particular, a handle axis 152a of the handle housing 52a extends at an angle other than 90° to the main extension plane 98a of the support surface 96a in the placement and/or storage position. The handle axis 152a is defined by the bow-shaped handle 18a. The handle axis 152a extends along the separating plane 146a and/or along the main extension plane 64a of the handle housing 52a, in particular along the main extension plane 42a of the bow-shaped handle 18a. The handle axis 152a corresponds to a main extension axis of a handle tube 234a of the bow-shaped handle 18a.

The main extension plane 232a of the tool holder surface 102a and the main extension plane 98a of the supporting surface 96a include an angle 104a which is greater than 80°. The angle 104a enclosed by the main extension plane 232a of the tool holder surface 102a and the main extension plane 98a of the supporting surface 96a has a value of less than 90° and greater than 80°. Particularly preferably, the angle 104a enclosed by the main extension plane 98a of the supporting surface 96a and the main extension plane 232a of the tool holder surface 102a has a value of at least substantially 86°.

The tool holder 12a, preferably the tool holder surface 102a, is inclined in the placement and/or storage position in a direction facing away from the work surface 94a. A normal 106a of the main extension plane 98a of the support surface 96a intersects the battery pack 38a and the center of gravity 26a of the sander 10a.

The support unit 92a is designed for placing and/or storing the sander 10a on the work surface 94a in at least one further placement and/or storage position, whereby the battery pack 38a comprises a further support surface 108a of the support unit 92a for the further placement and/or storage position. FIG. 8 shows the handheld power tool system 36a in the further placement and/or storage position.

In the further placement and/or storage position, the tool holder surface 102a extends at least substantially parallel to a support plane 116a of the further placement and/or storage position and/or to the flat work surface 94a. In the further placement and/or storage position, the drive axis 30a extends at least substantially perpendicular to the support plane 116a of the further placement and/or storage position. An edge 110a of the battery pack housing 112a of the battery pack 38a forms the further support surface 108a. The edge 110a is arranged facing away from the tool holder 12a.

A main extension axis 118a of the battery pack 38a extends at least substantially perpendicular to the main extension axis of the sander 10a. The edge 110a of the battery pack housing 112a extends at least substantially perpendicular to the main extension axis of the handheld power tool 50a, in particular the sander 10a.

The sander 10a comprises only one support point 114a, which comes to rest in the support plane 116a of the further placement and/or storage position. The support point 114a is located on the handle housing 52a. Alternatively, it is also conceivable that the support point 114a is located on the drive housing 54a. The support point 114a of the sander 10a is arranged on a side of the handle housing 52a facing away from the tool holder 12a. The support point 114a is located on a surface 264a of the palm grip 160a. The palm grip 160a has a round shape. The surface 264a of the palm grip 160a, on which the support point 114a is arranged, is designed to be curved. Alternatively, however, it is also conceivable that the surface 264a of the palm grip 160a, on which the support point 114a is arranged, is designed to be flat.

In the further placement and/or storage position, the further support surface 108a and the support point 114a of the sander 10a are situated in the support plane 116a of the further placement and/or storage position. In the further placement and/or storage position, the handheld power tool system 36a is in contact with the work surface 94a via the further support surface 108a on the battery pack 38a and via the support point 114a on the sander 10a.

The handheld power tool device 48a comprises the protective device 120a specified hereinabove, in particular a wall protection ring, which can be arranged on the handheld power tool 50a for collision protection of the tool 178a and/or the tool holder 12a against objects in a working environment of the handheld power tool 50a. The protective device 120a is designed in particular as a protective ring. The protective device 120a is preferably configured as a bumper for the handheld power tool 50a. In particular, the protective device 120a is intended to counteract a stop of the tool holder 12a and/or the tool 178a arranged on the tool holder 12a against walls or the like in the working environment.

The protective device 120a comprises a shutter unit 122a and/or a light guide unit 124a for at least one light source 132a.

The protective device 120a is arranged on the drive housing 54a in at least one operating state. The protective device 120a is intended to be arranged on the fan housing 166a. The shutter unit 122a is intended to shield a region from an incidence of light from the at least one light source 132a. The shutter unit 122a comprises multiple shutter elements 100a. Alternatively, it is conceivable that the shutter unit 122a comprises only one shutter element 100a. The shutter elements 100a are designed as opaque components. It is also conceivable that the shutter elements 100a are designed as reflectors, e.g. as mirrors or the like.

The protective device 120a comprises a base body 236a. The base body 236a comprises multiple windows 276a. The operator can look at the workpiece through the windows 276a when working on the workpiece. Alternatively, however, it is also conceivable that the base body 236a is designed without windows 276a.

The shutter unit 122a, in particular the shutter elements 100a, are designed to be integral with the base body 236a. The shutter unit 122a, in particular the shutter elements 100a, is/are formed by the base body 236a of the protective device 120a.

Alternatively, it is also conceivable that the shutter unit 122a, in particular the shutter elements 100a, is/are designed to be separate from the base body 236a. In particular, it is alternatively conceivable that the shutter unit 122a, preferably the shutter elements 100a, is/are attachable to the base body 236a, preferably detachably. It is also conceivable that the shutter unit 122a, in particular the shutter elements 100a, can be arranged adjustably on the base body 236a, preferably in order to adjust a shielding region by the shutter unit 122a.

The light guide unit 124a is arranged on the base body 236a. The light guide unit 124a in this case comprises, by way of example, three light guide elements 238a. Alternatively, it is conceivable that the light guide unit 124a comprises more or less than three light guide elements 238a. The light guide unit 124a is intended to guide and/or emit light from the at least one light source 132a. The light guide elements 238a are, by way of example, designed as transparent fibers, tubes, or rods. The light guide elements 238a are in this case, by way of example, designed as radiating elements, in particular as light-scattering elements, e.g. in the form of a roughening, a scattering glass, plastic or ceramic platelet, a scattering plastic film, or the like.

The shutter unit 122a is intended to block a light emission of at least one light source 132a at least in the direction of an intended operator side. The shutter unit 122a is intended to block a light emission of the at least one light source 132a in a direction facing away from the tool holder 12a.

It is conceivable that the protective device 120a comprises a light source unit 126a. The light source unit 126a comprises in this case, by way of example, two light sources 132a. Alternatively, it is also conceivable that the light source unit 126a comprises a different number of light sources 132a from two, for example only one light source 132a or more than two light sources 132a. Furthermore, it is alternatively conceivable that the protective device 120a is designed without a light source unit 126a. The light source unit 126a, in particular the light sources 132a, is/are arranged on the base body 236a. The light sources 132a are, e.g., designed as LEDs, as incandescent lamps or as another light source that a skilled person considers useful. Alternatively, it is also conceivable that the handheld power tool 50a comprises at least one of the light sources 132a.

It is also conceivable that the protective device 120a comprises at least one energy source 128a for at least one light source 132a. The protective device 120a comprises in this case, by way of example, two energy sources 128a. One of the energy sources 128a is associated with each of the light sources 132a. Alternatively, however, it is also conceivable that the protective device 120a comprises only one energy source 128a or more than two energy sources 128a or is designed without energy sources 128a. The energy sources 128a are, e.g., designed as batteries, rechargeable batteries, or the like.

The energy sources 128a are intended to supply energy to the respective light source 132a, in particular the light source unit 126a. The energy sources 128a are connected to the light sources 132a, in particular the light source unit 126a, at least in one operating state. Alternatively or additionally, however, it is also conceivable that the light sources 132a, in particular the light source unit 126a, are/can be supplied with electrical energy via the handheld power tool 50a, in particular the sander 10a, for example via an electrical plug connection between the protective device 120a and the handheld power tool 50a.

The protective device 120a in this case comprises, by way of example, an operating element 130a for the light sources 132a, in particular the light source unit 126a. The at least one operating element 130a is arranged on the base body 236a. The at least one operating element 130a can, e.g., be designed as a button, a rotary wheel, a switch, or the like. The at least one control element 130a can, e.g., be used to switch the light sources 132a on and/or off and/or to set a lighting parameter, e.g. a light color, an intensity, or the like.

Furthermore, it is conceivable that the protective device 120a comprises a sensor unit 134a for detecting an operation of the handheld power tool 50a, in particular for activating at least one light source 132a during operation of the handheld power tool 50a.

The sensor unit 134a is arranged on the base body 236a. The sensor unit 134a comprises at least one sensor element (not shown in this case), e.g. a vibration sensor or the like, for detecting operation of the handheld power tool 50a, in particular the sander 10a. The sensor unit 134a comprises control electronics (not shown in this case) for processing the sensor signals. The control electronics are connected to the light sources 132a for control purposes. The control electronics are intended to switch on the light sources 132a when operation of the handheld power tool 50a is detected. It is conceivable that the control electronics are a portion of the control unit 216a of the handheld power tool 50a. Alternatively, however, it is also conceivable that the control electronics are designed to be separate from the control unit 216a.

The protective device 120a is at least partially made of a thermoplastic elastomer. The base body 236a is at least partially made of a thermoplastic elastomer. At least one surface 240a of the protective device 120a facing away from the handheld power tool 50a, in particular of the base body 236a, is made of a thermoplastic elastomer.

It is also conceivable that the protective device 120a comprises a protective layer consisting at least partially of a thermoplastic elastomer. The protective layer can be a cover placed over the base body 236a, a layer glued to the base body 236a, or the like. Alternatively or additionally, it is also conceivable that the protective layer is clamped, screwed, or the like onto the base body 236a. Furthermore, it is also conceivable that the base body 236a is overmolded by the protective layer, in particular that the protective layer is overmolded onto the base body 236a, e.g. in a two-component injection molding process.

The protective device 120a comprises a fastening unit 284a for detachable fastening to the handheld power tool 50a (see FIGS. 9a and 9b). The fastening unit 284a comprises two pairs of fixing rails 286a extending parallel to each other. The fixing rails 286a each comprise a locking recess 288a.

The handheld power tool 50a, in particular the drive housing 54a, preferably the fan housing 166a, comprises a protective fastening unit 290a corresponding to the fastening unit 284a (see FIGS. 10a and 10b).

The protective mounting unit 290a comprises two fixing rails 292a. The fixing rails 292a of the protective fastening unit 290a are arranged between the fixing rails 286a of the fastening unit 284a in a state of the protective device 120a arranged on the handheld power tool 50a. The fixing rails 286a of the fastening unit 284a and the fixing rails 292a of the protective fastening unit 290a are intended for fixing in an axial direction relative to one another, preferably with respect to the drive axis 30a. The protective fastening unit 290a comprises two latching elements 294a, in particular latching hooks or the like. The latching elements 294a are intended to cooperate with the latching recesses 288a of the fastening unit 284a in order to fasten the protective device 120a to the handheld power tool 50a.

The protective device 120a has an asymmetrical basic shape, in particular adapted to a dust outlet 44a of the handheld power tool 50a. A shape of the base body 236a deviates from a circular shape along its longitudinal extent in at least one section, preferably in a region of the dust outlet 44a.

The handheld power tool device 48a comprises a damping unit 136a, which couples the drive housing 54a to the handle housing 52a. The drive housing 54a comprises an extension arm 138a extending at least radially with respect to the drive axis 30a. At least a portion 140a of the damping unit 136a is arranged on the extension arm 138a. The housing shells 84a, 86 are screwed together on the extension arm 138a, in particular via a screw dome 274a of the housing shells 84a, 86a. A screw dome 272a of the handle housing shells 192a, 194a in the region of the extension arm 138a is arranged at a distance from the screw dome 274a of the housing shells 84a, 86a.

The damping unit 136a comprises multiple damping elements 164a, 170a, 246a, 248a. The damping elements 164a, 170a, 246a, 248a are made of at least one elastic material, in particular an elastic plastic. The damping elements 164a, 170a, 246a, 248a can be designed as blocks, rings, ring segments, plates, or the like.

At least a portion of the damping elements 164a, 170a, 246a, 248a are fixed between the drive housing 54a and the handle housing 52a by means of a clamp. It is also conceivable that the damping elements 164a, 170a, 246a, 248a comprise an adhesive layer for attachment to the drive housing 54a and/or to the handle housing 52a. Additionally or alternatively, it is conceivable that at least a portion of the damping elements 164a, 170a, 246a, 248a can be attached to the handle housing 52a and/or the drive housing 54a by means of damping element holders, e.g. recesses, holding bolts, or the like, and/or by means of a screw connection or the like.

The portion 140a of the damping unit 136a on the extension arm 138a comprises, e.g., two damping elements 164a of the damping elements 164a, 170a, 246a, 248a. Alternatively, it is also conceivable that the portion 140a of the damping unit 136a on the extension arm 138a comprises only one damping element 164a or more than two damping elements 164a.

The drive housing 54a is connected to the handle housing 52a via the damping elements 164a, 170a, 246a, 248a. The damping unit 136a is intended for vibration decoupling of the handle housing 52a from the drive housing 54a. The handle housing 52a is coupled to the drive housing 54a via two different coupling regions 250a, 252a of the damping unit 136a. The handle housing 52a comprises two inner regions 226a, 254a at a distance from one another, in each of which a portion of the drive housing 54a is arranged. The two coupling regions 250a, 252a are arranged in the two inner regions 226a, 254a.

The extension arm 138a is arranged on a side of the drive housing 54a facing the battery pack interface 218a. The extension arm 138a is arranged within the handle housing 52a, in particular in a further inner region 254a of the two inner regions 226a, 254a of the handle housing 52a. The extension arm 138a forms an outermost point of the drive housing 54a when viewed in a direction perpendicular to the drive axis 30a and extending along the separating plane 146a. The extension arm 138a is at least partially enclosed by the handle housing 52a. It is also conceivable that the communication module 72a is arranged between the extension arm 138a and the battery pack interface 218a, in particular in the further inner region 254a.

The extension arm 138a comprises at least one damping element holder 256a for the damping elements 164a. The shape of the damping elements 164a is adapted to the damping element holder 256a. The damping element holder 256a comprises two holding bolts for holding one of the respective ring-shaped damping elements 164a. The damping element holder 256a is intended to hold the damping elements 164a perpendicular to the main extension plane 64a of the handle housing 52a, in particular to the main extension plane 42a of the bow-shaped handle 18a and/or to the separating plane 146a. The extension arm 138a is, by way of example, in this case T-shaped, particularly in order to hold the at least two dampening elements 164a.

Alternatively, however, it is also conceivable that, e.g., the damping element holder 256a is designed as a recess, in particular for holding a damping element 164a designed as a block, plate, or the like. The damping elements 164a are fixed to the damping element holder 256a via the handle housing 52a, in particular the handle housing shells 192a, 194a. Alternatively or additionally, however, it is also conceivable that the damping elements 164a are glued, screwed, or the like to the damping element holder 256a.

A maximum distance 142a of the extension arm 138a from the drive axis 30a is greater than a maximum distance 144a of the tool holder 12a from the drive axis 30a, in particular when viewed along a separating plane 146a of the handle housing 52a (see FIG. 6). A maximum distance 258a of the portion 140a of the damping unit 136a on the extension arm 138a from the drive axis 30a is greater than the maximum distance 144a of the tool holder 12a from the drive axis 30a, in particular as viewed along the separating plane 146a of the handle housing 52a.

A ratio of a maximum transverse extent 148a of the portion 140a of the damping unit 136a to a minimum distance 150a of the portion 140a of the damping unit 136a from the handle axis 152a of the handle housing 52a is at least 0.9 and at most 1.05. The maximum transverse extent 148a of the portion 140a of the damping unit 136a extends at least substantially perpendicular to the main extension plane 64a of the handle housing 52a, in particular the main extension plane 42a of the bow-shaped handle 18a, and/or the separating plane 146a. The maximum transverse extent 148a of the portion 140a of the damping unit 136a extends at least substantially parallel to the tool holder surface 102a. The minimum distance 150a of the portion 140a of the damping unit 136a from the handle axis 152a is measured parallel to the separating plane 146a, in particular to the main extension plane 42a of the bow-shaped handle 18a, preferably to the main extension plane 64a of the handle housing 52a.

The maximum transverse extent 148a of the portion 140a of the damping unit 136a is in this case, by way of example, at least 40 mm, preferably at least 45 mm. The maximum transverse extent 148a of the portion 140a of the damping unit 136a is in this case, by way of example, at most 60 mm, preferably at most 50 mm. The maximum transverse extent 148a of the portion 140a of the damping unit 136a is defined by a maximum distance between the two damping elements 164a, in particular in a direction perpendicular to the main extension plane 42a of the bow-shaped handle 18a.

A ratio of the maximum transverse extent 148a of the portion 140a of the damping unit 136a to the maximum height 34a of the sander 10a is preferably at least 0.35, preferably at least 0.4. The ratio of the maximum transverse extent 148a of the portion 140a of the damping unit 136a to the maximum height 34a of the sander 10a is preferably at most 0.5, preferably at most 0.45.

The minimum distance 150a of the portion 140a of the damping unit 136a from the handle axis 152a is preferably at least 45 mm, preferably at least 50 mm. The minimum distance 150a of the portion 140a of the damping unit 136a from the handle axis 152a is preferably at most 60 mm, preferably at most 55 mm. Alternatively, however, it is also conceivable that the minimum distance 150a of the portion 140a of the damping unit 136a from the handle axis 152a is less than 45 mm or greater than 60 mm.

A ratio between the maximum transverse extent 148a of the portion 140a of the damping unit 136a and a minimum distance 154a of the portion 140a of the damping unit 136a from the drive axis 30a is at least 0.7, preferably at least 0.73. The ratio between the maximum transverse extent 148a of the portion 140a of the damping unit 136a and the minimum distance 154a of the portion 140a of the damping unit 136a from the drive axis 30a is at most 0.8, preferably at most 0.75. The minimum distance 154a of the portion 140a of the damping unit 136a from the drive axis 30a is measured parallel to the separating plane 146a, in particular to the main extension plane 42a of the bow-shaped handle 18a, preferably to the main extension plane 64a of the handle housing 52a.

The minimum distance 154a of the portion 140a of the damping unit 136a from the drive axis 30a is preferably at least 55 mm, preferably at least 60 mm. The minimum distance 154a of the portion 140a of the damping unit 136a from the drive axis 30a is preferably at most 70 mm, preferably at most 65 mm. Alternatively, however, it is also conceivable that the minimum distance 154a of the portion 140a of the damping unit 136a from the drive axis 30a is less than 55 mm or greater than 70 mm.

A ratio between a maximum height 156a of the housing unit 16a and the minimum distance 150a of the portion 140a of the damping unit 136a on the extension arm 138a from the handle axis 152a of the handle housing 52a is at most 2.25. The maximum height 156a of the housing unit 16a extends along the separating plane 146a, in particular along the main extension plane 64a of the handle housing 52a, preferably along the main extension plane 42a of the bow-shaped handle 18a.

The maximum height 156a of the housing unit 16a extends parallel to the drive axis 30a. The maximum height 156a of the housing unit 16a is in this case, by way of example, at least 90 mm, preferably at least 100 mm. The maximum height 156a of the housing unit 16a is in this case, by way of example, at most 120 mm, preferably at most 110 mm. Alternatively, however, it is also conceivable that the maximum height 156a of the housing unit 16a in the direction of the drive axis 30a is less than 90 mm or greater than 120 mm.

A ratio between a maximum extent 296a of the damping unit 136a, in particular a maximum distance 298a of the damping elements 164a, 170a, 246a, 248a, in the direction of the drive axis 30a and the maximum height 156a of the housing unit 16a is at least 0.8, preferably at least 0.85. A ratio between the maximum extent 296a of the damping unit 136a, in particular the maximum distance 298a of the damping elements 164a, 170a, 246a, 248a in the direction of the drive axis 30a and the maximum height 34a of the sander 10a is at least 0.7, preferably at least 0.75. The maximum extent 296a of the damping unit 136a, in particular the maximum distance 298a of the damping elements 164a, 170a, 246a, 248a, in the direction of the drive axis 30a is in this case, by way of example, at least 85 mm, preferably at least 90 mm (see FIG. 4).

A ratio between the minimum distance 154a of the portion 140a of the damping unit 136a from the drive axis 30a in a direction perpendicular to the drive axis 30a and a maximum longitudinal extent 158a of the housing unit 16a is greater than 0.3. The maximum longitudinal extent 158a of the housing unit 16a extends perpendicular to the drive axis 30a. The maximum longitudinal extent 158a of the housing unit 16a extends at least substantially parallel to the tool holder surface 102a. The maximum longitudinal extent 158a of the housing unit 16a extends along the separating plane 146a, preferably along the main extension plane 64a of the handle housing 52a, in particular the main extension plane 42a of the bow-shaped handle 18a.

The maximum longitudinal extent 158a of the housing unit 16a is preferably at least 175 mm, preferably at least 180 mm. The maximum longitudinal extent 158a of the housing unit 16a is preferably at most 190 mm, preferably at most 185 mm. Alternatively, however, it is also conceivable that the maximum longitudinal extent 158a of the housing unit 16a is less than 175 mm or greater than 190 mm.

A ratio between the minimum distance 154a between the portion 140a of the damping unit 136a and the drive axis 30a and the minimum distance 150a between the portion 140a of the damping unit 136a and the handle axis 152a of the handle housing 52a is at least 1.2 and at most 1.3.

The bow-shaped handle 18a is supported via the portion 140a of the damping unit 136a and/or via the extension arm 138a on the drive housing 54a to form the closed handle recess 20a of the bow-shaped handle 18a.

The portion 140a of the damping unit 136a and/or the extension arm 138a is arranged in the direction of the handle axis 152a at the height of the handle recess 20a. The portion 140a of the damping unit 136a on the extension arm 138a and/or the extension arm 138a is, viewed in the direction of the handle axis 152a, arranged at least substantially completely within the maximum longitudinal extent 22a of the handle recess 20a.

The two damping elements 164a of the portion 140a of the damping unit 136a on the extension arm 138a are arranged at a distance from one another. The damping elements 164a are arranged on opposite sides of the extension arm 138a. The damping elements 164a are arranged on mutually different sides of the separating plane 146a, in particular the main extension plane 64a of the handle housing 52a, preferably the main extension plane 42a of the bow-shaped handle 18a. The damping elements 164a are arranged mirror-symmetrically with respect to the separating plane 146a, in particular the main extension plane 64a of the handle housing 52a, preferably the main extension plane 42a of the bow-shaped handle 18a.

The extension arm 138a is arranged on the fan housing 166a. The extension arm 138a is designed to be at least partially integral with the fan housing 166a. The extension arm 138a is arranged on a side of the fan housing 166a facing the battery pack interface 218a. The fan housing 166a is arranged between the motor housing 78a and the tool holder 12a. The extraction fan 168a is made of metal, in particular cast metal. Alternatively, however, it is also conceivable that the extraction fan 168a is made of plastic or a combination of plastic and metal.

The motor housing 78a and the fan housing 166a are at least partially designed to be integral with one another. The fan housing 166a and the motor housing 78a comprise common housing shells 84a, 86a. The two housing shells 84a, 86a each comprise one half of the fan housing 166a and one half of the motor housing 78a.

Two further damping elements 170a of the damping unit 136a are, e.g., arranged on the motor housing 78a such that the damping elements 170a are only partially enclosed by the handle housing 52a in a sectional plane 172a perpendicular to the drive axis 30a as viewed through the respective damping element 170a. Alternatively, however, it is also conceivable that the damping unit 136a comprises only one further damping element 170a or more than two further damping elements 170a.

The two further damping elements 170a are arranged between the handle housing 52a and the motor housing 78a. The two further damping elements 170a are arranged inside the handle housing 52a. The two further damping elements 170a are arranged on opposite sides of the motor housing 78a, in particular on different housing shells 84a, 86a. The two further damping elements 170a are arranged on different sides of the separating plane 146a and/or the drive housing separating plane 228a. The two further damping elements 170a are arranged symmetrically to the parting plane 146a and/or to the drive housing separating plane 228a. The two further damping elements 170a are designed to be cube-shaped. The further damping elements 170a are arranged at the height of the air outlet openings 74a when viewed in the axial direction.

The damping unit 136a comprises two sealing elements 174a, in particular a sealing ring in order to block an inlet of exhaust air into the handle housing 52a. The sealing elements 174a are arranged between the handle housing 52a and the drive housing 54a.

The sealing elements 174a are designed as circular arc segments. The sealing elements 174a are arranged inside the handle housing 52a. The sealing elements 174a are arranged on opposite sides of the motor housing 78a, in particular on different housing shells 84a, 86a. The sealing elements 174a are arranged on different sides of the separating plane 146a and/or the drive housing separating plane 228a. The sealing elements 174a are arranged symmetrically to separating plane 146a and/or to the drive housing separating plane 228a.

Alternatively, however, it is also conceivable that the damping unit 136a comprises only one sealing element 174a or more than two sealing elements 174a. The sealing elements 174a surround the motor housing 78a in a circumferential direction, which in particular extends in a plane perpendicular to the drive axis 30a, at least substantially completely, preferably in an angular range of at least 270°, preferably of at least 330°, and particularly preferably of at least 350°.

The sealing elements 174a are intended to at least substantially completely fill a gap between the motor housing 78a and the handle housing 52a. The sealing elements 174a are made of an elastic material, preferably an elastic plastic. The sealing elements 174a preferably have material hardness that is different from that of the damping elements 164a, 170a, 246a, 248a. The material hardness of the sealing elements 174a is lower than a material hardness of the damping elements 164a, 170a, 246a, 248a. Alternatively, it is conceivable that the sealing elements 174a and the damping elements 164a, 170a, 246a, 248a have an identical material hardness. The sealing elements 174a are arranged above the air outlet openings 74a with respect to the tool holder 12a. The sealing elements 174a are additionally intended to support and/or decouple the handle housing 52a from the drive housing 54a.

The damping unit 136a comprises four additional damping elements 246a. Alternatively, however, it is also conceivable that the damping unit 136a comprises fewer than four additional damping elements 246a or more than four additional damping elements 246a. The additional damping elements 246a are arranged between the handle housing 52a and the motor housing 78a. The additional damping elements 246a are arranged within the handle housing 52a. The additional damping elements 246a are arranged uniformly in a circumferential direction of the motor housing 78a, which in particular extends in a plane perpendicular to the drive axis 30a.

In each case, two of the additional damping elements 246a are arranged on opposite sides of the motor housing 78a, in particular on different housing shafts 84a, 86a. In each case, two of the additional damping elements 246a are arranged on different sides of the separating plane 146a and/or the drive housing separating plane 228a.

The additional damping elements 246a are arranged symmetrically to separating plane 146a and/or the drive housing separating plane 228a. The additional damping elements 246a are designed to be cube-shaped. The two sealing elements 174a are arranged between the further damping elements 170a and the additional damping elements 246a when viewed in the axial direction.

The damping unit 136a comprises a further additional damping element 248a. The further additional damping element 248a is intended for damping axial relative movements, in particular vibrations, between the drive housing 54a and the handle housing 52a with respect to the drive axis 30a and/or for axial support between the handle housing 52a and the drive housing 54a. Alternatively or additionally, however, it is also conceivable that the further additional damping element 248a is intended for damping radial movements and/or for radial support between the handle housing 52a and the drive housing 54a. The further additional damping element 248a is preferably arranged in an extension of the motor axis 260a, preferably between the motor housing 78a and the handle housing 52a.

The further additional damping element 248a is in this case, by way of example, designed in the shape of a circular cylinder. Alternatively, however, it is also conceivable that the further additional damping element 248a is designed to be cube-shaped or the like. The further additional damping element 248a is in this case, by way of example, arranged in a preloaded manner between the drive housing 54a and the handle housing 52a.

The maximum extent 296a of the damping unit 136a, in particular the maximum distance 298a of the damping elements 164a, 170a, 246a, 248a, in the direction of the drive axis 30a is defined by a maximum distance between the further additional damping element 248a and the damping elements 164a in the direction of the drive axis 30a.

FIG. 11 shows a schematic sequence of a method for manufacturing a handheld power tool device 48a, in particular the one specified hereinabove. The protective device 120a is made at least partially of a thermoplastic elastomer.

In one method step, in particular a shaping step 242a, the base body 236a is shaped. In one method step, in particular an overmolding step 244a, the base body 236a is overmolded by a protective layer of thermoplastic elastomer. Alternatively, it is also conceivable that the base body 236a is already at least partially molded by a thermoplastic elastomer, in particular during the molding step 242a.

FIG. 12 shows a further exemplary embodiment of the invention. The following descriptions and the drawings are substantially limited to the differences between the exemplary embodiments, whereby reference can also be made in principle to the drawings and/or the description of the other exemplary embodiments, in particular FIGS. 1 to 11, with regard to components with the same designation, in particular with regard to components having the same reference signs. To differentiate between the exemplary embodiments, the letter a is placed after the reference signs of the exemplary embodiment in FIGS. 1 to 11. In the exemplary embodiment in FIG. 12, the letter a is replaced by the letter b.

FIG. 12 shows a handheld power tool system 36b comprising a handheld power tool 50b. The handheld power tool 50b is designed as a sander 10b. The handheld power tool 50b is designed as a battery-operated sander. Alternatively, however, it is also conceivable that the handheld power tool 50b, in particular the sander 10b, is designed as a grid-powered handheld power tool. The sander 10b is designed as a random orbital sander. Alternatively, however, it is also conceivable that the sander 10b is designed as an orbital sander, a delta sander, or the like.

The handheld power tool 50b comprises a tool holder 12b, in particular a sanding pad for holding a tool 178b. The handheld power tool 50b comprises a drive unit (not shown in this case) for driving the tool holder 12b.

The handheld power tool 50b comprises a housing unit 16b.

The housing unit 16b comprises a handle housing 52b and a fan housing 166b for holding an extraction fan. The fan housing 166b is designed as a metal housing, in particular as an aluminum housing. Alternatively, however, it is also conceivable that the fan housing 166b is at least partially designed as a plastic housing. The handle housing 52b comprises a bow-shaped handle 18b. The handle housing 52b is coupled to the fan housing 166b. A drive unit, in particular at least one electric motor, of the handheld power tool 50b is arranged in the handle housing 52b.

A ratio of a maximum longitudinal extent of a handle recess 20b of the bow-shaped handle 18b to a maximum longitudinal extent of the tool holder 12b is at least 0.35 and at most 0.5. The bow-shaped handle 18b is designed to be closed. Viewed in the main extension plane of the bow-shaped handle 18b, the handle recess 20b is enclosed, in particular delimited, by walls of the handle housing 52b. The fan housing 166b lies directly against the handle housing 52b. The handle housing 52b comprises air outlet openings 74b.

The handheld power tool 50b comprises a handheld power tool device 48b. The housing unit 16b is a portion of the handheld power tool device 48b. The fan housing 166b comprises a center bar 60b on a surface of an upper side of the fan housing 166b that is raised relative to the surface. The center bar 60b drops onto the surface in both directions starting from a main extension plane (not shown in this case) of the handle housing 52b and extending perpendicularly to the main extension plane of the handle housing 52b.

The handheld power tool system 36b comprises a battery pack 38b for supplying power to the handheld power tool 50b. The handheld power tool system 36b comprises a support unit 92b, which is designed for placing and/or storing the sander 10b on a work surface (not shown in this case) in at least one placement and/or storage position, whereby the battery pack 38b comprises a support surface of the support unit 92b for the at least one placement and/or storage position.

The handheld power tool 50b comprises a holder 68b for a operator interface 70b of the handheld power tool 50b. The holder 68b is delimited by the handle housing 52b and the fan housing 166b.

1. A sander comprising:
a tool holder;
a drive unit configured to drive the tool holder; and
a housing unit having a bow-shaped handle defining a handle recess,
wherein a ratio between a maximum longitudinal extent of the handle recess of the bow-shaped handle and a maximum longitudinal extent of the tool holder is at least 0.35 and at most 0.5.

2. The sander according to claim 1, wherein a center of gravity of the sander is arranged in the handle recess.

3. The sander according to claim 2, wherein a ratio between a maximum distance of the tool holder from the center of gravity in a direction of a drive axis of the drive unit and a minimum distance between the drive axis and the center of gravity is at least 2.8 and at most 3.5.

4. The sander according to claim 3, wherein a maximum height of the sander in a the direction of a drive axis of the drive unit has a ratio of at least 2.8 and at most 3.2 to the maximum distance of the tool holder and the center of gravity in the direction of the drive axis.

5. The sander according to claim 1, wherein the handle recess is ovally closed.

6. A handheld power tool system comprising:
a sander including (i) a tool holder, (ii) a drive unit configured to drive the tool holder, and (iii) a housing unit having a bow-shaped handle defining a handle recess; and
a battery pack configured to be arranged on the sander,
wherein a ratio between a maximum longitudinal extent of the handle recess of the bow-shaped handle and a maximum longitudinal extent of the tool holder is at least 0.35 and at most 0.5.

7. The handheld power tool system according to claim 6, wherein the battery pack has a battery pack center of gravity which, when the battery pack is in a state arranged on the sander, the battery pack center of gravity is offset from a main extension plane of the bow-shaped handle.

8. The handheld power tool system according to claim 7, wherein:
the sander comprises a dust outlet, and
the battery pack center of gravity and the dust outlet are arranged on different sides of the main extension plane of the bow-shaped handle.

9. The handheld power tool system according to claim 7, wherein when the battery pack is arranged on the sander a ratio between a minimum distance between the battery pack center of gravity and a drive axis of the drive unit and a maximum longitudinal extent of the tool holder is at least 0.85 and at most 1.2.

10. The handheld power tool system according to claim 6, wherein an overall center of gravity of the handheld power tool system is arranged in the handle recess of the bow-shaped handle when the battery pack is arranged on the sander.

11. The handheld power tool system according to claim 6, wherein a ratio between a minimum distance between a battery pack center of gravity of the battery pack in a state arranged on the sander and a drive axis of the drive unit and a maximum longitudinal extent of a handle recess of the bow-shaped handle is at least 2.0 and at most 3.0.
